(19) United States
(12) Patent Application Publication
(10) Pub. No.: US 2026/0039867 A1
(43) Pub. Date: Feb. 5, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai Zhang, Los Angeles, CA (US); Li Zhang, Los Angeles, CA (US); Li Zhang, Los Angeles, CA (US)

(21) Appl. No.: 19/356,804

(22) Filed: Oct. 13, 2025

Related U.S. Application Data
(63) Continuation of application No. PCT/CN2024/087629, filed on Apr. 12, 2024.

(30) Foreign Application Priority Data
Apr. 13, 2023 (WO) PCT/CN2023/088177

(51) Int. Cl. H04N 19/593; H04N 19/11; H04N 19/119; H04N 19/132; H04N 19/137; H04N 19/176; H04N 19/184

(52) U.S. Cl. CPC H04N 19/593; H04N 19/11; H04N 19/119; H04N 19/132; H04N 19/137; H04N 19/176; H04N 19/184

(57) ABSTRACT

Embodiments of the present disclosure provide a solution for video processing. A method for video processing is proposed. In the method, for a conversion between a target video block of a video and a bitstream of the video, a usage of an interweaved affine prediction is determined based on at least one of a first coding tool, or coding information of the target video block. The conversion is performed based on the usage of the interweaved affine prediction.

### CROSS REFERENCE TO RELATED APPLICATIONS

This application is a continuation of International Application No. PCT/CN2024/087629, filed on Apr. 12, 2024, which claims the benefit of International Application No. PCT/CN2023/088177 filed on Apr. 13, 2023. The entire contents of these applications are hereby incorporated by reference in their entireties.

### FIELDS

Embodiments of the present disclosure relate generally to video processing techniques, and more particularly, to interweaved affine prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a target video block of a video and a bitstream of the video, a usage of an interweaved affine prediction based on at least one of a first coding tool, or coding information of the target video block; and performing the conversion based on the usage of the interweaved affine prediction.

The method in accordance with the first aspect of the present disclosure improves the coding efficiency.

In a second aspect, another method for video processing is proposed. The method comprises: determining, for a conversion between a target video block of a video and a bitstream of the video, a usage of a coding unit (CU) level overlapped block motion compensation (OBMC) based on a coding mode of the target video block; and performing the conversion based on the usage of the CU-level OBMC.

The method in accordance with the second aspect of the present disclosure improves the coding efficiency.

In a third aspect, another method for video processing is proposed. The method comprises: determining, for a conversion between a target video block of a video and a bitstream of the video, motion fields of at least two coding units coded before the target video block; determining at least one regression affine candidate of the target video block based on the motion fields of the at least two coding units; and performing the conversion based on the at least one regression affine candidate. The method in accordance with the third aspect of the present disclosure improves the coding efficiency.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining a usage of an interweaved affine prediction based on at least one of a first coding tool, or coding information of a target video block of the video; and generating the bitstream based on the usage of the interweaved affine prediction.

In a seventh aspect, another non-transitory computer-readable recording medium is proposed. The non-transitory computer-readable recording medium stores a bitstream of a video which is generated by a method performed by an apparatus for video processing. The method comprises: determining a usage of an interweaved affine prediction based on at least one of a first coding tool, or coding information of a target video block of the video; generating the bitstream based on the usage of the interweaved affine prediction; and storing the bitstream in a non-transitory computer-readable recording medium.

In an eighth aspect, another non-transitory computer-readable recording medium is proposed. The non-transitory computer-readable recording medium stores a bitstream of a video which is generated by a method performed by an apparatus for video processing. The method comprises: determining a usage of a coding unit (CU) level overlapped block motion compensation (OBMC) based on a coding mode of a target video block of the video; and generating the bitstream based on the usage of the CU-level OBMC.

In a ninth aspect, a method for storing a bitstream of a video is proposed. The method comprises: determining a usage of a coding unit (CU) level overlapped block motion compensation (OBMC) based on a coding mode of a target video block of the video; generating the bitstream based on the usage of the CU-level OBMC; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by an apparatus for video processing. The method comprises: determining motion fields of at least two coding units coded before a target video block of the video; determining at least one regression affine candidate of the target video block based on the motion fields of the at least two coding units; and generating the bitstream based on the at least one regression affine candidate.

In an eleventh aspect, a method for storing a bitstream of a video is proposed. The method comprises: determining motion fields of at least two coding units coded before a target video block of the video; determining at least one regression affine candidate of the target video block based on the motion fields of the at least two coding units; generating the bitstream based on the at least one regression affine candidate; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6 illustrates control point based affine motion model;

FIG. 7 illustrates an example affine MVF per subblock;

FIG. 8 illustrates locations of inherited affine motion predictors;

FIG. 9 illustrates control point motion vector inheritance;

FIG. 10 illustrates locations of Candidates position for constructed affine merge mode;

FIG. 11 illustrates spatial neighbors for deriving affine merge candidates;

FIG. 12 illustrates from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performs on a search area around initial MV;

FIG. 16 illustrates template and the corresponding reference template;

FIG. 17 illustrates template and reference template for block with sub-block motion using the motion information of the subblocks of current block;

FIG. 18 illustrates deriving sub-CU motion field obtained by applying a motion shift based on the neighboring motion information;

FIG. 19 illustrates an example of interweaved prediction;

FIG. 20A-FIG. 20G illustrate exemplary dividing patterns for a 16×16 block;

FIG. 21A-FIG. 21D illustrate examples of partial interweaved prediction. Interweaved prediction is not applied on shaded areas;

FIG. 22A-FIG. 22C illustrate examples of deriving MVs for one dividing pattern from another dividing pattern;

FIG. 23A-FIG. 23C illustrate examples of choosing dividing patterns depending on block dimensions;

FIG. 24A and FIG. 24B illustrate examples of deriving MVs of sub-blocks in one component within a dividing pattern from MVs of sub-block in another component within another dividing pattern;

FIG. 25 illustrates examples of CU level OBMC;

FIG. 26 illustrates a flowchart of a method for video processing in accordance with embodiments of the present disclosure;

FIG. 27 illustrates a flowchart of another method for video processing in accordance with embodiments of the present disclosure;

FIG. 28 illustrates a flowchart of another method for video processing in accordance with embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

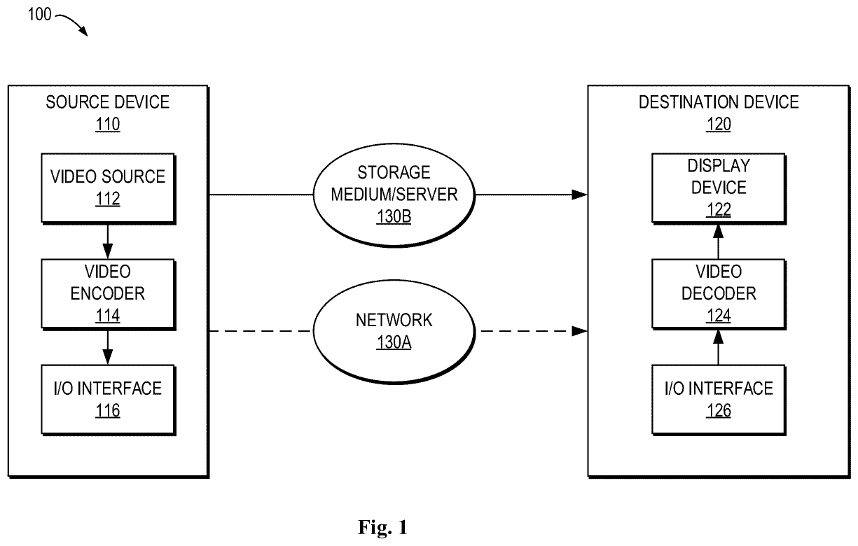

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

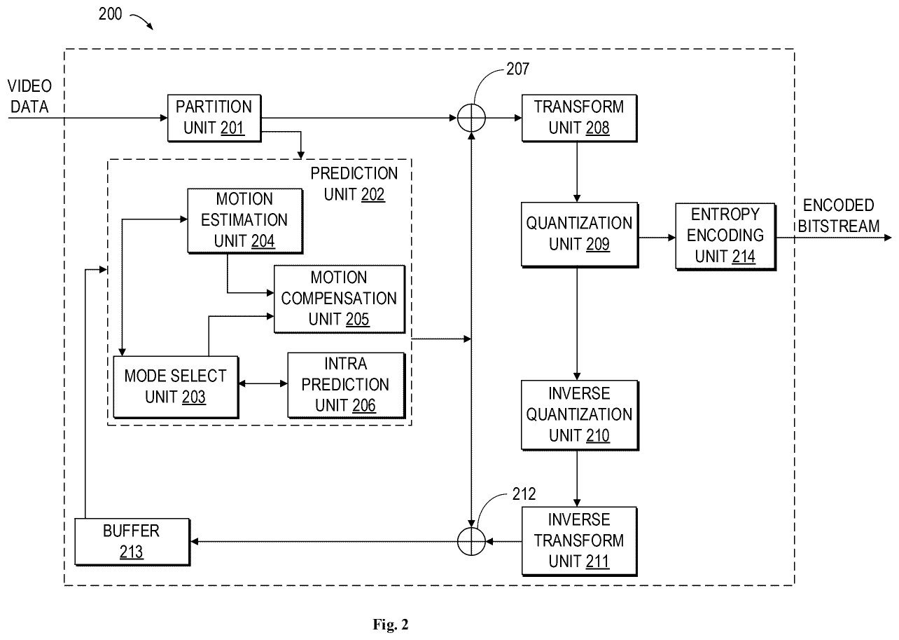

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block.

The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

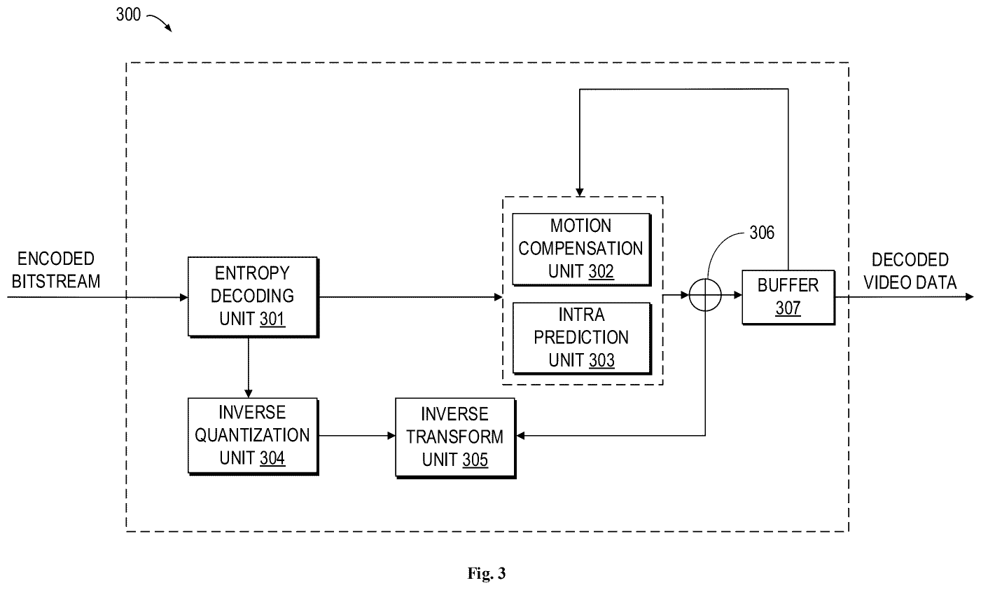

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about Affine motion prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

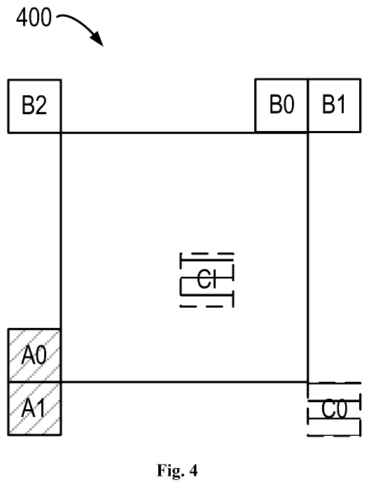

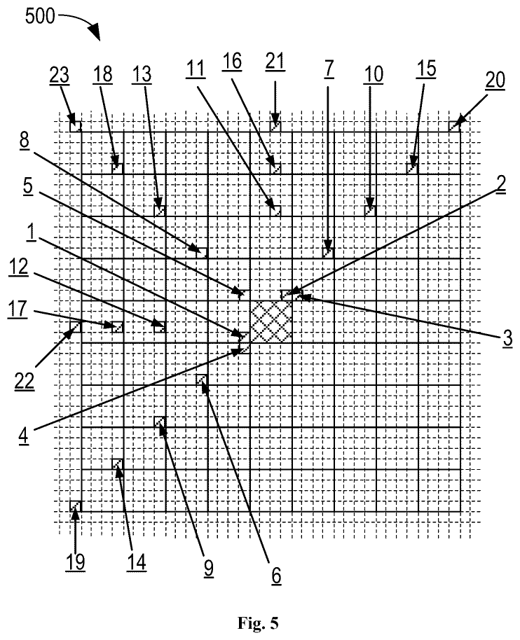

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates positions of spatial and temporal neighboring blocks used in AMVP/merge candidate list construction. For spatial motion vector candidate derivation, two motion vector candidates are eventually derived based on motion vectors of blocks located in five different positions as depicted in FIG. 1. The five neighboring blocks located at B0, B1, B2, and AG, AI are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (CO) and central (Cl)) checked in order, as depicted in FIG. 1. To avoid redundant MV candidates, duplicated motion vector candidates in the list are abandoned. If the number of potential candidates is smaller than two, additional zero motion vector candidates are added to the list. FIG. 5 illustrates positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (CO and Cl). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP.

In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 2.

### 2.2. Affine Motion Compensated Prediction

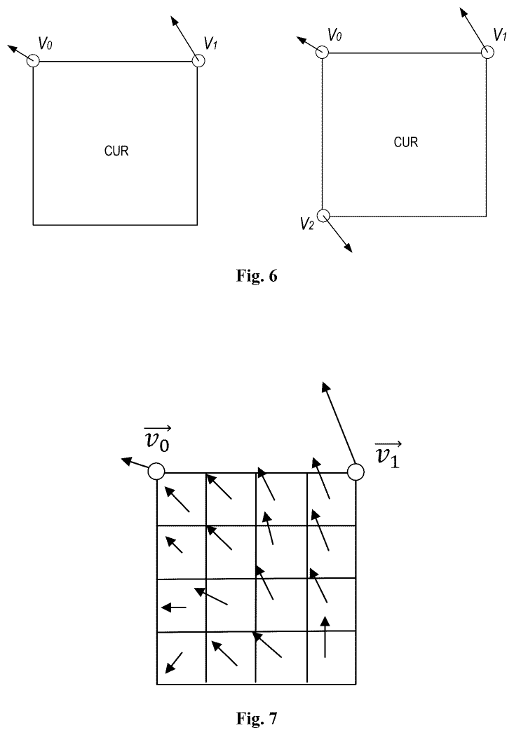

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. FIG. 6 illustrates control point based affine motion model, for example (a) 4 parameter affine model and (b) 6 parameter affine model. As shown in FIG. 6, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}m {ν}_{x} = \frac{m {ν}_{1 x} - m {ν}_{0 x}}{W} x + \frac{m {ν}_{1 y} - m {ν}_{0 y}}{W} y + m {ν}_{0 x} \\ m {ν}_{y} = \frac{m {ν}_{1 y} - m {ν}_{0 y}}{W} x + \frac{m {ν}_{1 y} - m {ν}_{0 x}}{W} y + m {ν}_{0 y}\end{matrix} . \qquad ( 1 )$$

For 6-parameter affine motion model, motion vector at sample location (x, y) in a block is derived as:

$$\{ \begin{matrix}m {ν}_{x} = \frac{m {ν}_{1 x} - m {ν}_{0 x}}{W} x + \frac{m {ν}_{2 x} - m {ν}_{0 y}}{H} y + m {ν}_{0 x} \\ m {ν}_{y} = \frac{m {ν}_{1 y} - m {ν}_{0 y}}{W} x + \frac{m {ν}_{2 y} - m {ν}_{0 x}}{H} y + m {ν}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point.

To simplify the motion compensation prediction, block based affine transform prediction is applied. FIG. 7 illustrates an example affine MVF per subblock. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.2.1. Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. In VVC, the following three types of CPVM candidate are used to form the affine merge candidate list:
Inherited affine merge candidates that extrapolated from the CPMVs of the neighbour CUs.
Constructed affine merge candidates CPMVPs that are derived using the translational MVs of the neighbour CUs.
Zero MVs.

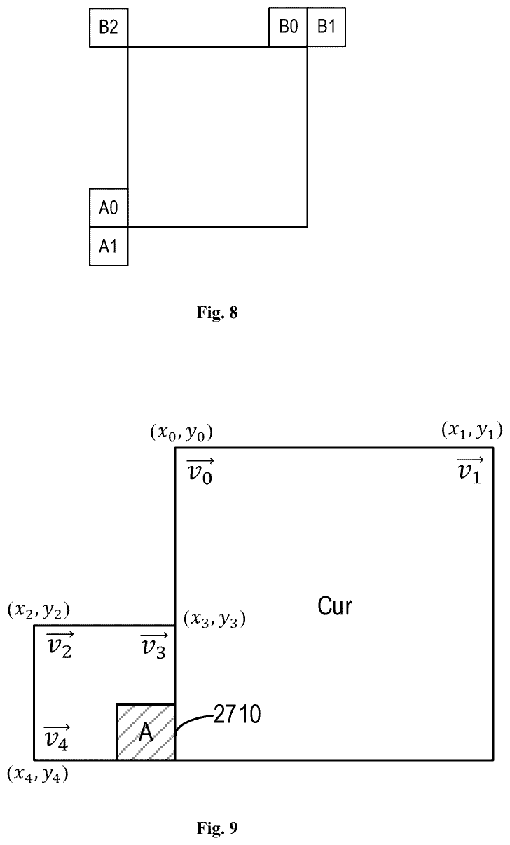

In VVC, there are maximum two inherited affine candidates, which are derived from affine motion model of the neighboring blocks, one from left neighboring CUs and one from above neighboring CUs. FIG. 8 illustrates locations of inherited affine motion predictors. The candidate blocks are shown in FIG. 8. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 9 illustrates control point motion vector inheritance. As shown in FIG. 9, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

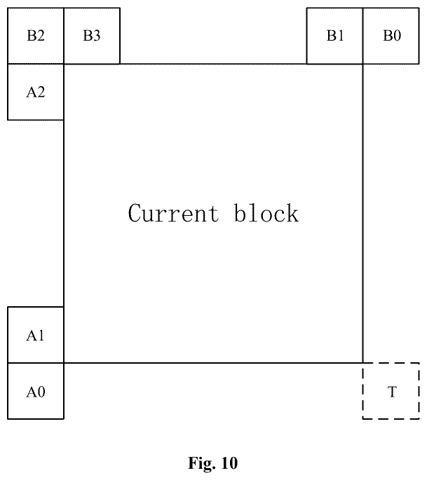

Constructed affine candidate means the candidate is constructed by combining the neighbor translational motion information of each control point. The motion information for the control points is derived from the specified spatial neighbors and temporal neighbor shown in FIG. 10. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order:
{CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

FIG. 10 illustrates locations of Candidates position for constructed affine merge mode.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and it is generated by using the following four types of CPVM candidate in order:
Inherited affine AMVP candidates that extrapolated from the CPMVs of the neighbour CUs.
Constructed affine AMVP candidates CPMVPs that are derived using the translational MVs of the neighbour CUs.
Translational MVs from neighboring CUs.
Zero MVs.

The checking order of inherited affine AMVP candidates is same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

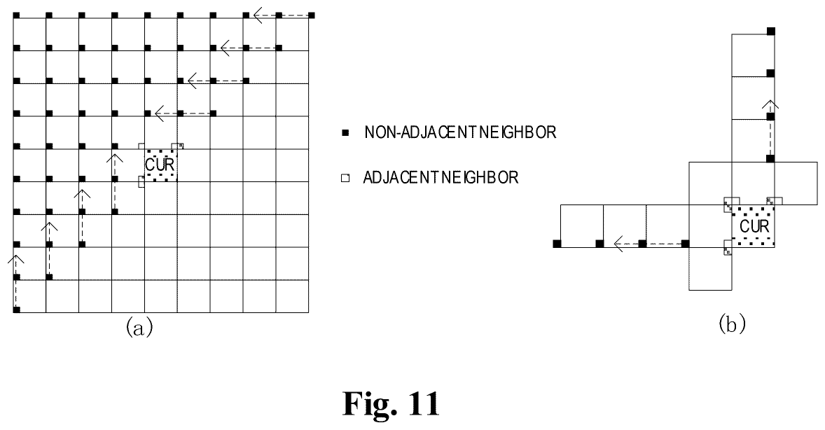

FIG. 11 illustrates spatial neighbors for deriving affine merge candidates: (a) for deriving inherited affine merge candidates (b) for deriving constructed affine merge candidates.

If affine AMVP list candidates is still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods in ECM-8.0

In ECM-6.0, 3 additional Affine merge and AMVP candidate derivation methods are integrated, which are non-adjacent spatial candidates, History-parameter-based candidates, Regression based affine candidates and Pixel based affine motion compensation.

### 2.2.3.1. Non-Adjacent Spatial Candidates

In ECM-6.0, non-adjacent spatial neighbors are investigated to provided candidates for both Affine merge and Affine AMVP. The pattern of obtaining non-adjacent spatial candidates is shown in FIG. 11. Same as the non-adjacent regular merge candidates, the distances between non-adjacent spatial candidates and current coding block are also defined based on the width and height of current CU.

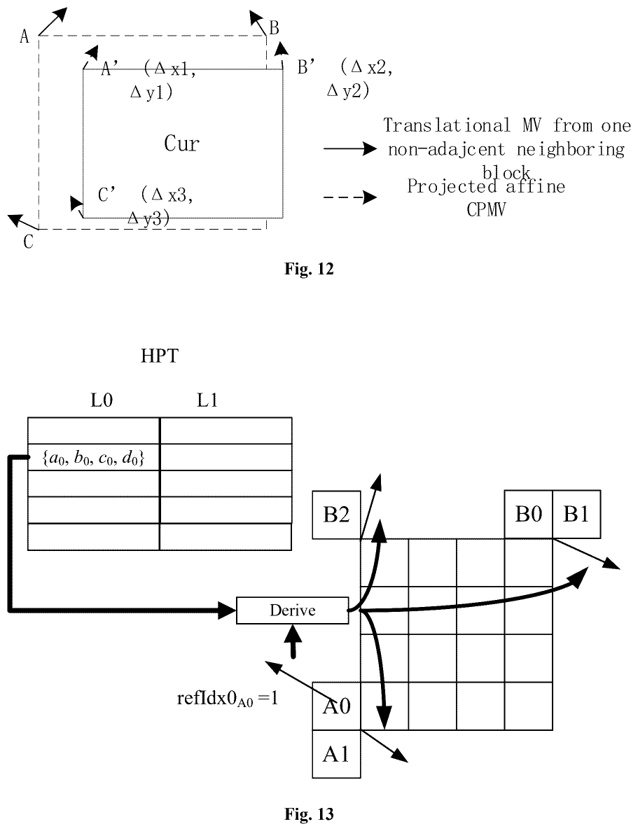

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) \qquad ( 3 )$$

wherein RefList and Refldx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and Refldxcur, the affine parameters are utilized to update entries in the category HPTCat(RefListcur, Refldxcur) in a way similar to HMVP table updating.

A history-affine-parameter-based candidate (HAPC) is derived from a neighbouring 4×4 block denoted as AG, A1, B0, B1 or B2 in FIG. 13 and a set of affine parameters stored in a corresponding entry in HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows an example of how to derive an HAPC from block AG. The affine parameters {a0, b0, c0, d0} are directly fetched from one entry of category HPTIdx(RefListA0, refldxOA0) in HPT. The affine parameters from HPT, with the center position of AG as the base position, and the MV of block AG as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

FIG. 13 illustrates an example of generating an HAPC.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

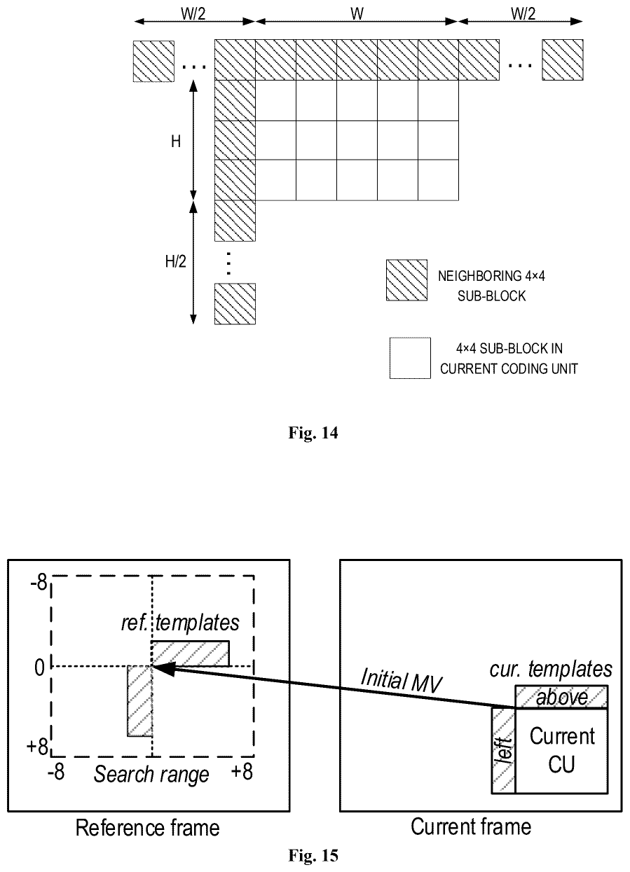

The previously coded affine CU can be identified from scanning through non-adjacent positions and the affine HMVP table. FIG. 14 illustrates an illustration of regression based affine merge candidate derivation. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

### 2.2.3.4. Pixel Based Affine Motion Compensation

With pixel based affine motion compensation, minimum affine subblock size is set to lxi for luma component when OBMC is not applied, minimum subblock size is always set to lxi for chroma components.

### 2.3. Template Matching Merge/AMVP Mode in ECM

Template matching (TM) merge/AMVP mode is a decoder-side MV derivation method to refine the motion information of the current CU by finding the closest match between a template (i.e., top and/or left neighboring blocks of the current CU) in the current picture and ablock (i.e., same size to the template) in a reference picture. FIG. 15 illustrates template matching performs on a search area around initial MV. As illustrated in FIG. 15, a better MV is to be searched around the initial motion of the current CU within a [−8, +8]-pel search range. In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered.

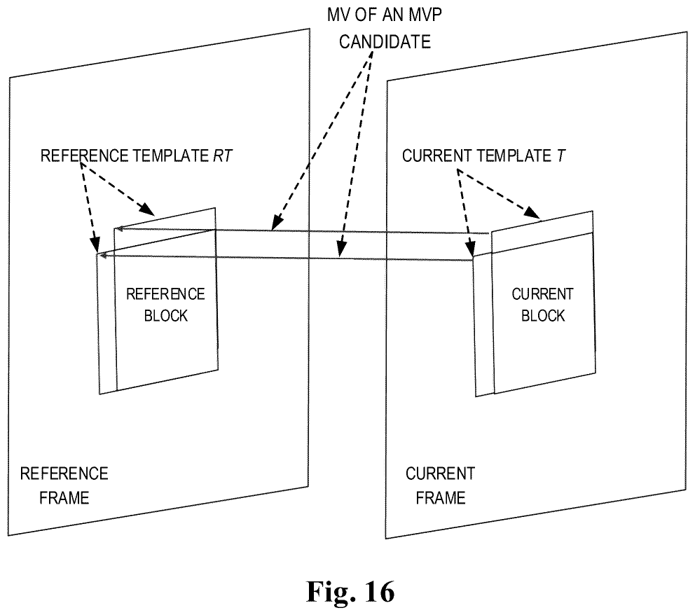

The template matching cost is measured by the sum of absolute differences (SAD) between samples of a template of the current block and their corresponding reference template. FIG. 16 illustrates template and the corresponding reference template. The template comprises a set of reconstructed samples neighboring to the current block, while reference template is located by the same motion information of the current block, as illustrated in FIG. 16.

When a merge candidate utilizes bi-directional prediction, the reference samples of the template of the merge candidate are also generated by bi-prediction.

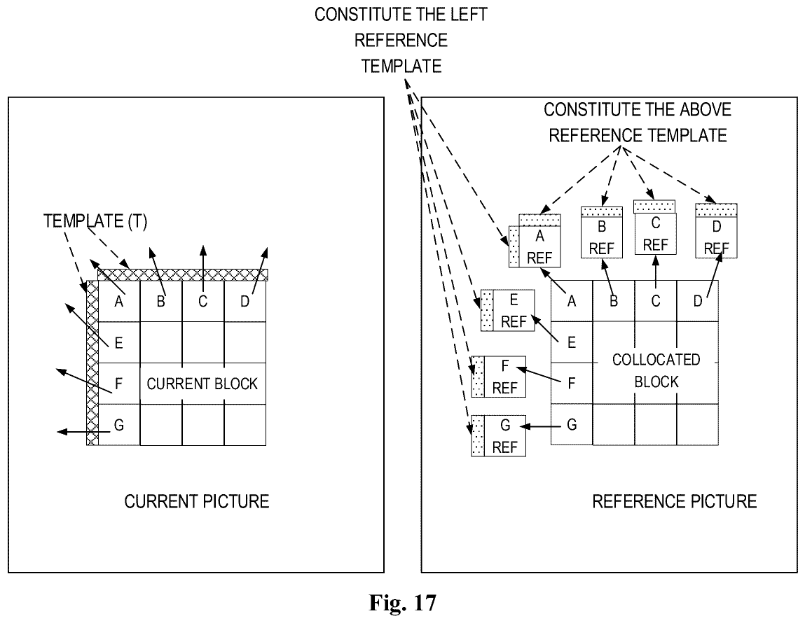

For subblock-based merge candidates with subblock size equal to Wsub * Hsub, the above template comprises several sub-templates with the size of Wsub x K, and the left template comprises several sub-templates with the size of K×Hsub. FIG. 17 illustrates template and reference template for block with sub-block motion using the motion information of the subblocks of current block. As shown in FIG. 17, the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTMVP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

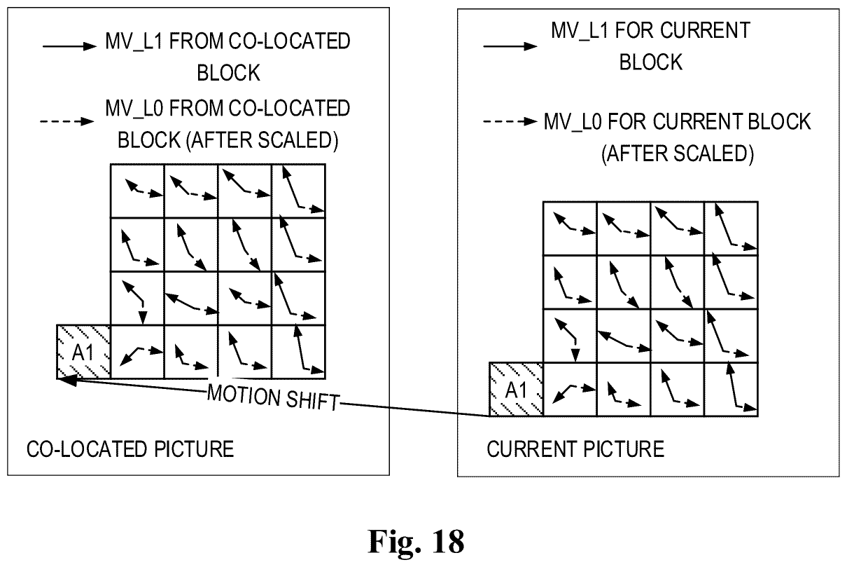

FIG. 18 illustrates the derivation process of the sub-block level motion field for SbTMVP. In particular, the motion information of left-bottom sub-block AI is firstly fetched, if either of the MVs in reference listO and list1 points to the collocated frame, then the corresponding MV will be identified as motion shift. Otherwise, zero my will be used as motion shift.

Once the motion shift is determined, the specified region in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.6. Deblocking Process in VVC

### 8.6.2 Deblocking Filter Process

### 8.6.2.1 General

Inputs to this process are the reconstructed picture prior to deblocking, i.e., the array recPictureL and, when ChromaArrayType is not equal to 0, the arrays recPictureCb and recPictureCr.

Outputs of this process are the modified reconstructed picture after deblocking, i.e., the array recPictureL and, when ChromaArrayType is not equal to 0, the arrays recPictureCb and recPictureCr.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

NOTE—Although the filtering process is specified on a picture basis in this Specification, the filtering process can be implemented on a coding unit basis with an equivalent result, provided the decoder properly accounts for the processing dependency order so as to produce the same output values.

The deblocking filter process is applied to all coding subblock edges and transform block edges of a picture, except the following types of edges:
Edges that are at the boundary of the picture,
Edges that coincide with tile boundaries when loop_filter_across_tiles_enabled_flag is equal to 0,
Edges that coincide with upper or left boundaries of tile groups with tile_group_loop_filter_across tile_groups_enabled flag equal to 0 or tile_group_deblocking_filter_dⁱsabled_flag equal to 1,
Edges within tile groups with tilegroup_deblocking_filter_disabled flag equal to 1,
Edges that do not correspond to 8×8 sample grid boundaries of the considered component,
Edges within chroma components for which both sides of the edge use inter prediction,
Edges of chroma transform blocks that are not edges of the associated transform unit. [Ed. (BB): Adapt syntax once tiles are integrated.]

The edge type, vertical or horizontal, is represented by the variable edgeType as specified in Table 8 17.

TABLE 8 17
Name of association to edgeType

| edgeType | Name of edgeType |
|---|---|
| 0 (vertical edge) | EDGE_VER |
| 1 (horizontal edge) | EDGE_HOR |

When tilegroup_deblocking_filter_disabled flag of the current tile group is equal to 0, the following applies:
The variable treeType is derived as follows:
If tile_group_type is equal to I and qtbtt_dual_tree_intra_flag is equal to 1, treeType is set equal to DUAL_TREE_LUMA.
Otherwise, treeType is set equal to SINGLE_TREE.
The vertical edges are filtered by invoking the deblocking filter process for one direction as specified in clause 8.6.2.2 with the variable treeType, the reconstructed picture prior to deblocking, i.e., the array recPictureL and, when ChromaArrayType is not equal to 0 or treeType is equal to SINGLE_TREE, the arrays recPictureCb and recPictureCr, and the variable edgeType set equal to EDGE_VER as inputs, and the modified reconstructed picture after deblocking, i.e., the array recPictureL and, when ChromaArrayType is not equal to 0 or treeType is equal to SINGLE_TREE, the arrays recPictureCb and recPictureCr as outputs.
The horizontal edge are filtered by invoking the deblocking filter process for one direction as specified in clause 8.6.2.2 with the variable treeType, the modifed reconstructed picture after deblocking, i.e., the array recPictureL and, when ChromaArrayType is not equal to 0 or treeType is equal to SINGLE_TREE, the arrays recPictureCb and recPictureCr, and the variable edgeType set equal to EDGE_HOR as inputs, and the modified reconstructed picture after deblocking, i.e., the array recPictureL and, when ChromaArrayType is not equal to 0 or treeType is equal to SINGLE_TREE, the arrays recPictureCb and recPictureCr as outputs.
When tile_group_type is equal to I and qtbtt_dual_tree_intra flag is equal to 1, the following applies:
The variable treeType is set equal to DUAL_TREE_CHROMA.
The vertical edges are filtered by invoking the deblocking filter process for one direction as specified in clause 8.6.2.2 with the variable treeType, the reconstructed picture prior to deblocking, i.e., the arrays recPictureCb and recPictureCr, and the variable edgeType set equal to EDGE_VER as inputs, and the modified reconstructed picture after deblocking, i.e., the arrays recPictureCb and recPictureCr as outputs.
The horizontal edge are filtered by invoking the deblocking filter process for one direction as specified in clause 8.6.2.2 with the variable treeType, the modifed reconstructed picture after deblocking, i.e., the arrays recPictureCb and recPictureCr, and the variable edgeType set equal to EDGE_HOR as inputs, and the modified reconstructed picture after deblocking, i.e., the arrays recPictureCb and recPictureCr as outputs.

### 8.6.2.2 Deblocking Filter Process for One Direction

Inputs to this process are:
the variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a variable edgeType specifying whether a vertical (EDGE VER) or a horizontal (EDGE HOR) edge is filtered.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

For each coding unit with coding block width log 2CbW, coding block height log 2CbH and location of top-left sample of the coding block (xCb, yCb), when edgeType is equal to EDGE_VER and xCb % 8 is equal 0 or when edgeType is equal to EDGE_HOR and yCb % 8 is equal to 0, the edges are filtered by the following ordered steps:
1. The coding block width nCbW is set equal to 1 log 2CbW and the coding block height nCbH is set equal to«log 2CbH.
2. The variable filterEdgeFlag is derived as follows:
If edgeType is equal to EDGE_VER and one or more of the following conditions are true, filterEdgeFlag is set equal to 0:
The left boundary of the current coding block is the left boundary of the picture.
The left boundary of the current coding block is the left boundary of the tile and loop_filter_across_tiles_enabled_flag is equal to 0.
The left boundary of the current coding block is the left boundary of the tile group and tile_group_loop_filter_across tile_groups_enabled flag is equal to 0.
Otherwise if edgeType is equal to EDGE_HOR and one or more of the following conditions are true, the variable filterEdgeFlag is set equal to 0:
The top boundary of the current luma coding block is the top boundary of the picture.
The top boundary of the current coding block is the top boundary of the tile and loop_filter_across_tiles_enabled_flag is equal to 0.
The top boundary of the current coding block is the top boundary of the tile group and tile_group_loop_filter_across tile_groups_enabled flag is equal to 0.
Otherwise, filterEdgeFlag is set equal to 1. [Ed. (BB): Adapt syntax once tiles are integrated.]
3. All elements of the two-dimensional (nCbW)x(nCbH) array edgeFlags are initialized to be equal to zero.
4. The derivation process of transform block boundary specified in clause 8.6.2.3 is invoked with the location (xB0, yB0) set equal to (0, 0), the block width nTbW set equal to nCbW, the block height nTbH set equal to nCbH, the variable treeType, the variable filterEdgeFlag, the array edgeFlags, and the variable edgeType as inputs, and the modified array edgeFlags as output.
5. The derivation process of coding subblock boundary specified in clause 8.6.2.4 is invoked with the location (xCb, yCb), the coding block width nCbW, the coding block height nCbH, the array edgeFlags, and the variable edgeType as inputs, and the modified array edgeFlags as output.
6. The picture sample array recPicture is derived as follows:
If treeType is equal to SINGLE_TREE or DUAL_TREE_LUMA, recPicture is set equal to the reconstructed luma picture sample array prior to deblocking recPictureL.
Otherwise (treeType is equal to DUAL_TREE_CHROMA), recPicture is set equal to the reconstructed chroma picture sample array prior to deblocking recPictureCb.
7. The derivation process of the boundary filtering strength specified in clause 8.6.2.5 is invoked with the picture sample array recPicture, the luma location (xCb, yCb), the coding block width nCbW, the coding block height nCbH, the variable edgeType, and the array edgeFlags as inputs, and an (nCbW)x(nCbH) array verBs as output.
8. The edge filtering process is invoked as follows:
If edgeType is equal to EDGE_VER, the vertical edge filtering process for a coding unit as specified in clause 8.6.2.6.1 is invoked with the variable treeType, the reconstructed picture prior to deblocking, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, the location (xCb, yCb), the coding block width nCbW, the coding block height nCbH, and the array verBs as inputs, and the modified reconstructed picture, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, as output.
Otherwise if edgeType is equal to EDGE_HOR, the horizontal edge filtering process for a coding unit as specified in clause 8.6.2.6.2 is invoked with the variable treeType, the modified reconstructed picture prior to deblocking, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, the location (xCb, yCb), the coding block width nCbW, the coding block height nCbH, and the array horBs as inputs and the modified reconstructed picture, i.e., when treeType is equal to SINGLE_TREE or DUAL_TREE_LUMA, the array recPictureL and, when ChromaArrayType is not equal to 0 and treeType is equal to SINGLE_TREE or DUAL_TREE_CHROMA, the arrays recPictureCb and recPictureCr, as output.

### 8.6.2.3 Derivation Process of Transform Block Boundary

Inputs to this process are:
a location (xB0, yB0) specifying the top-left sample of the current block relative to the top left sample of the current coding block,
a variable nTbW specifying the width of the current block,
a variable nTbH specifying the height of the current block,
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
a variable filterEdgeFlag,
a two-dimensional (nCbW)x(nCbH) array edgeFlags,
a variable edgeType specifying whether a vertical (EDGE VER) or a horizontal (EDGE HOR) edge is filtered.

Output of this process is the modified two-dimensional (nCbW)x(nCbH) array edgeFlags.

The maximum transform block size maxTbSize is derived as follows:

$$max TbSize = ( treeType == DUAL\_TREE \_CHROMA ) ? Max TbSizeY / 2 : MaxTbSizeY . \qquad ( 8 \; 862 )$$

Depending on maxTbSize, the following applies:
If nTbW is greater than maxTbSize or nTbH is greater than maxTbSize, the following ordered steps apply.
1. The variables newTbW and newTbH are derived as follows:

$$newTbW = ( nTbW > max TbSize ) ? ( nTbW / 2 ) : nTbW \qquad ( 8 \; 863 )$$

$$newTbH = ( nTbH > max TbSize ) ? ( nTbH / 2 ) : nTbH . \qquad ( 8 \; 864 )$$

2. The derivation process of transform block boundary as specified in this clause is invoked with the location (xB0, yB0), the variables nTbW set equal to newTbW and nTbH set equal to newTbH, the variable filterEdgeFlag, the array edgeFlags, and the variable edgeType as inputs, and the output is the modified version of array edgeFlags.
3. If nTbW is greater than maxTbSize, the derivation process of transform block boundary as specified in this clause is invoked with the luma location (xTb0, yTb0) set equal to (xTb0+newTbW, yTb0), the variables nTbW set equal to newTbW and nTbH set equal to newTbH, the variable filterEdgeFlag, the array edgeFlags and the variable edgeType as inputs, and the output is the modified version of array edgeFlags.
4. If nTbH is greater than maxTbSize, the derivation process of transform block boundary as specified in this clause is invoked with the luma location (xTb0, yTb0) set equal to (xTb0, yTb0+newTbH), the variables nTbW set equal to newTbW and nTbH set equal to newTbH, the variable filterEdgeFlag, the array edgeFlags and the variable edgeType as inputs, and the output is the modified version of array edgeFlags.
5. If nTbW is greater than maxTbSize and nTbH is greater than maxTbSize, the derivation process of transform block boundary as specified in this clause is invoked with the luma location (xTb0, yTb0) set equal to (xTb0+newTbW, yTb0+newTbH), the variables nTbW set equal to newTbW and nTbH set equal to newTbH, the variable filterEdgeFlag, the array edgeFlags and the variable edgeType as inputs, and the output is the modified version of array edgeFlags.
Otherwise, the following applies:
If edgeType is equal to EDGE_VER, the value of edgeFlags[xB0][yB0+k] for k=0.nTbH −1 is derived as follows:
If xB0 is equal to 0, edgeFlags[xB0][yB0+k] is set equal to filterEdgeFlag.
Otherwise, edgeFlags[xB0][yB0+k] is set equal to 1.
Otherwise (edgeType is equal to EDGE_HOR), the value of edgeFlags[xB0+k][yB0] for k=0.nTbW
1 is derived as follows:
If yB0 is equal to 0, edgeFlags[xB0+k][yB0] is set equal to filterEdgeFlag.
Otherwise, edgeFlags[xB0+k][yB0] is set equal to 1.

### 8.6.2.4 Derivation Process of Coding Subblock Boundary

Inputs to this process are:
a location (xCb, yCb) specifying the top-left sample of the current coding block relative to the top-left sample of the current picture,
a variable nCbW specifying the width of the current coding block,
a variable nCbH specifying the height of the current coding block,
a two-dimensional (nCbW)x(nCbH) array edgeFlags,
a variable edgeType specifying whether a vertical (EDGE VER) or a horizontal (EDGE HOR) edge is filtered.

Output of this process is the modified two-dimensional (nCbW)x(nCbH) array edgeFlags.

The number of coding subblock in horizontal direction numSbX and in vertical direction numSbY are derived as follows:
If CuPredMode[xCb][yCb]==MODE_INTRA, numSbX and numSbY are both set equal to 1.
Otherwise, numSbX and numSbY are set equal to NumSbX[xCb][yCb] and NumSbY[xCb][yCb], respectively.

Depending on the value of edgeType the following applies:
If edgeType is equal to EDGE_VER and numSbX is greater than 1, the following applies for

$$i = 1 … min ( ( nCbW / 8 ) - 1 , numSbX - 1 ) , k = 0 … nCbH - 1 : edgeFlags [ i * Max ( 8 , nCbW / numSbX ) ] [ k ] = 1. \qquad ( 8 \; 865 )$$

Otherwise if edgeType is equal to EDGE_HOR and numSbY is greater than 1, the following applies for

$$j = 1 … min ( ( nCbH / 8 ) - 1 , numSbY - 1 ) , k = 0 … nCbW - 1 : edgeFlags [ k ] [ j * Max ( 8 , nCbH / numSbY ) ] = 1. \qquad ( 8 \; 866 )$$

### 8.6.2.5 Derivation Process of Boundary Filtering Strength

Inputs to this Process are:
a picture sample array recPicture,
a location (xCb, yCb) specifying the top-left sample of the current coding block relative to the top-left sample of the current picture,
a variable nCbW specifying the width of the current coding block,
a variable nCbH specifying the height of the current coding block,
a variable edgeType specifying whether a vertical (EDGE VER) or a horizontal (EDGE HOR) edge is filtered,
a two-dimensional (nCbW)x(nCbH) array edgeFlags.

Output of this process is a two-dimensional (nCbW)x(nCbH) array bS specifying the boundary filtering strength.

The variables xDi, yDj, xN and yN are derived as follows:
If edgeType is equal to EDGE_VER, xDi is set equal to (i«3), yDj is set equal to (j«2), xN is set equal to Max(0, (nCbW/8)−1) and yN is set equal to (nCbH/4)−1.
Otherwise (edgeType is equal to EDGE_HOR), xDi is set equal to (i«2), yDj is set equal to (j«3), xN is set equal to (nCbW/4)−1 and yN is set equal to Max(0, (nCbH/8)−1).

For xDi with i=0.xN and yDj with j=0.yN, the following applies:
If edgeFlags[xDi][yDj] is equal to 0, the variable bS [xDi][yDj] is set equal to 0.
Otherwise, the following applies:
The sample values p0 and q0 are derived as follows:
If edgeType is equal to EDGE_VER, p0 is set equal to recPicture [xCb+xDi−1][yCb+yDj] and q0 is set equal to recPicture [xCb+xDi][yCb+yDj].
Otherwise (edgeType is equal to EDGE_HOR), p0 is set equal to recPicture [xCb+xDi][yCb+yDj−1] and q0 is set equal to recPicture [xCb+xDi][yCb+yDj].
The variable bS [xDi][yDj] is derived as follows:
If the sample p0 or q0 is in the coding block of a coding unit coded with intra prediction mode, bS[xDi][yDj] is set equal to 2.
Otherwise, if the block edge is also a transform block edge and the sample p0 or q0 is in a transform block which contains one or more non-zero transform coefficient levels, bS [xDi][yDj] is set equal to 1.
Otherwise, if one or more of the following conditions are true, bS [xDi][yDj] is set equal to 1:
For the prediction of the coding subblock containing the sample p0 different reference pictures or a different number of motion vectors are used than for the prediction of the coding subblock containing the sample q0.

NOTE 1—The determination of whether the reference pictures used for the two coding sublocks are the same or different is based only on which pictures are referenced, without regard to whether a prediction is formed using an index into reference picture list 0 or an index into reference picture list 1, and also without regard to whether the index position within a reference picture list is different.

NOTE 2—The number of motion vectors that are used for the prediction of a coding subblock with top-left sample covering (xSb, ySb), is equal to PredFlagLO[xSb][ySb]+PredFlagL1[xSb][ySb].
One motion vector is used to predict the coding subblock containing the sample p0 and one motion vector is used to predict the coding subblock containing the sample q0, and the absolute difference between the horizontal or vertical component of the motion vectors used is greater than or equal to 4 in units of quarter luma samples.
Two motion vectors and two different reference pictures are used to predict the coding subblock containing the sample p0, two motion vectors for the same two reference pictures are used to predict the coding subblock containing the sample q0 and the absolute difference between the horizontal or vertical component of the two motion vectors used in the prediction of the two coding subblocks for the same reference picture is greater than or equal to 4 in units of quarter luma samples.
Two motion vectors for the same reference picture are used to predict the coding subblock containing the sample p0, two motion vectors for the same reference picture are used to predict the coding subblock containing the sample q0 and both of the following conditions are true:
The absolute difference between the horizontal or vertical component of list 0 motion vectors used in the prediction of the two coding subblocks is greater than or equal to 4 in quarter luma samples, or the absolute difference between the horizontal or vertical component of the list 1 motion vectors used in the prediction of the two coding subblocks is greater than or equal to 4 in units of quarter luma samples.
The absolute difference between the horizontal or vertical component of list 0 motion vector used in the prediction of the coding subblock containing the sample p0 and the list 1 motion vector used in the prediction of the coding subblock containing the sample q0 is greater than or equal to 4 in units of quarter luma samples, or the absolute difference between the horizontal or vertical component of the list 1 motion vector used in the prediction of the coding subblock containing the sample p0 and list 0 motion vector used in the prediction of the coding subblock containing the sample q0 is greater than or equal to 4 in units of quarter luma samples.
Otherwise, the variable bS[xDi][yDj] is set equal to 0.

### 8.6.2.6 Edge Filtering Process

8.6.2.6.1 Vertical Edge Filtering Process Inputs to this process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a location (xCb, yCb) specifying the top-left sample of the current coding block relative to the top-left sample of the current picture,
a variable nCbW specifying the width of the current coding block,
a variable nCbH specifying the height of the current coding block.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

When treeType is equal to SINGLE_TREE or DUAL_TREE_LUMA, the filtering process for edges in the luma coding block of the current coding unit consists of the following ordered steps:

1. The variable xN is set equal to Max(0, (nCbW/8)−1) and yN is set equal to (nCbH/4)−1. 2. For xDk equal to k«3 with k=0.nN and yDm equal to m«2 with m=0.yN, the following applies:
When bS[xDk][yDm] is greater than 0, the following ordered steps apply:
a. The decision process for block edges as specified in clause 8.6.2.6.3 is invoked with treeType, the picture sample array recPicture set equal to the luma picture sample array recPictureL, the location of the luma coding block (xCb, yCb), the luma location of the block (xDk, yDm), a variable edgeType set equal to EDGE_VER,the boundary filtering strength bS[xDk][yDm], and the bit depth bD set equal to BitDepthY as inputs, and the decisions dE, dEp and dEq, and the variable tC as outputs.
b. The filtering process for block edges as specified in clause 8.6.2.6.4 is invoked with the picture sample array recPicture set equal to the luma picture sample array recPictureL, the location of the luma coding block (xCb, yCb), the luma location of the block (xDk, yDm), a variable edgeType set equal to EDGE_VER, the decisions dE, dEp and dEq, and the variable tC as inputs, and the modified luma picture sample array recPictureL as output.

When ChromaArrayType is not equal to 0 and treeType is equal to SINGLE_TREE the filtering process for edges in the chroma coding blocks of current coding unit consists of the following ordered steps:
1. The variable xN is set equal to Max(0, (nCbW/8)−1) and yN is set equal to Max(0, (nCbH/8) -1).
2. The variable edgeSpacing is set equal to 8/SubWidthC.
3. The variable edgeSections is set equal to yN * (2/SubHeightC).
4. For xDk equal to k*edgeSpacing with k=0.xN and yDm equal to m«2 with m=0.edgeSections, the following applies:
When bS[xDk * SubWidthC][yDm * SubHeightC] is equal to 2 and (((xCb/SubWidthC+xDk)»3) 3) is equal to xCb/SubWidthC+xDk, the following ordered steps apply:
a. The filtering process for chroma block edges as specified in clause 8.6.2.6.5 is invoked with the chroma picture sample array recPictureCb, the location of the chroma coding block (xCb/SubWidthC, yCb/SubHeightC), the chroma location of the block (xDk, yDm), a variable edgeType set equal to EDGE_VER and a variable cQpPicOffset set equal to pps_cb_qp_offset as inputs, and the modified chroma picture sample array recPictureCb as output.
b. The filtering process for chroma block edges as specified in clause 8.6.2.6.5 is invoked with the chroma picture sample array recPictureCr, the location of the chroma coding block (xCb/SubWidthC, yCb/SubHeightC), the chroma location of the block (xDk, yDm), a variable edgeType set equal to EDGE_VER and a variable cQpPicOffset set equal to pps_cr_qp_offset as inputs, and the modified chroma picture sample array recPictureCr as output.

When treeType is equal to DUAL_TREE_CHROMA, the filtering process for edges in the two chroma coding blocks of the current coding unit consists of the following ordered steps:
1. The variable xN is set equal to Max(0, (nCbW/8)−1) and yN is set equal to (nCbH/4)−1.
2. For xDk equal to k«3 with k=0.xN and yDm equal to m«2 with m=0.yN, the following applies:
When bS[xDk][yDm] is greater than 0, the following ordered steps apply:
a. The decision process for block edges as specified in clause 8.6.2.6.3 is invoked with treeType, the picture sample array recPicture set equal to the chroma picture sample array recPictureCb, the location of the chroma coding block (xCb, yCb), the location of the chroma block (xDk, yDm), a variable edgeType set equal to EDGE_VER, the boundary filtering strength bS[xDk][yDm], and the bit depth bD set equal to BitDepthC as inputs, and the decisions dE, dEp and dEq, and the variable tC as outputs.
b. The filtering process for block edges as specified in clause 8.6.2.6.4 is invoked with the picture sample array recPicture set equal to the chroma picture sample array recPictureCb, the location of the chroma coding block (xCb, yCb), the chroma location of the block (xDk, yDm), a variable edgeType set equal to EDGE_VER, the decisions dE, dEp and dEq, and the variable tC as inputs, and the modified chroma picture sample array recPictureCb as output.
c. The filtering process for block edges as specified in clause 8.6.2.6.4 is invoked with the picture sample array recPicture set equal to the chroma picture sample array recPictureCr, the location of the chroma coding block (xCb, yCb), the chroma location of the block (xDk, yDm), a variable edgeType set equal to EDGE_VER, the decisions dE, dEp and dEq, and the variable tC as inputs, and the modified chroma picture sample array recPictureCr as output.

### 8.6.2.6.2 Horizontal Edge Filtering Process

Inputs to this Process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
when treeType is equal to SINGLE_TREE or DUAL_TREE_LUMA, the reconstructed picture prior to deblocking, i.e., the array recPictureL,
when ChromaArrayType is not equal to 0 and treeType is equal to SINGLE_TREE or DUAL_TREE_CHROMA, the arrays recPictureCb and recPictureCr,
a location (xCb, yCb) specifying the top-left sample of the current coding block relative to the top-left sample of the current picture,
a variable nCbW specifying the width of the current coding block,
a variable nCbH specifying the height of the current coding block.

Outputs of this process are the modified reconstructed picture after deblocking, i.e:
when treeType is equal to SINGLE_TREE or DUAL_TREE_LUMA, the array recPictureL,
when ChromaArrayType is not equal to 0 and treeType is equal to SINGLE_TREE or DUAL_TREE_CHROMA, the arrays recPictureCb and recPictureCr.

When treeType is equal to SINGLE_TREE or DUAL_TREE_LUMA, the filtering process for edges in the luma coding block of the current coding unit consists of the following ordered steps:

1. The variable yN is set equal to Max(0, (nCbH/8)−1) and xN is set equal to (nCbW/4)−1.
2. For yDm equal to m«3 with m=0.yN and xDk equal to k«2 with k=0.xN, the following applies:
When bS[xDk][yDm] is greater than 0, the following ordered steps apply:
a. The decision process for block edges as specified in clause 8.6.2.6.3 is invoked with treeType, the picture sample array recPicture set equal to the luma picture sample array recPictureL, the location of the luma coding block (xCb, yCb), the luma location of the block (xDk, yDm), a variable edgeType set equal to EDGE_HOR, the boundary filtering strength bS[xDk][yDm], and the bit depth bD set equal to BitDepthY as inputs, and the decisions dE, dEp and dEq, and the variable tC as outputs.
b. The filtering process for block edges as specified in clause 8.6.2.6.4 is invoked with the picture sample array recPicture set equal to the luma picture sample array recPictureL, the location of the luma coding block (xCb, yCb), the luma location of the block (xDk, yDm), a variable edgeType set equal to EDGE_HOR, the decisions dEp, dEp and dEq, and the variable tC as inputs, and the modified luma picture sample array recPictureL as output.

When ChromaArrayType is not equal to 0 and treeType is equal to SINGLE_TREE the filtering process for edges in the chroma coding blocks of current coding unit consists of the following ordered steps:
1. The variable xN is set equal to Max(0, (nCbW/8)−1) and yN is set equal to Max(0, (nCbH/8)−1).
2. The variable edgeSpacing is set equal to 8/SubHeightC.
3. The variable edgeSections is set equal to xN * (2/SubWidthC).
4. For yDm equal to m * edgeSpacing with m=0.yN and xDk equal to k«2 with k=0.edgeSections, the following applies:
When bS[xDk * SubWidthC][yDm * SubHeightC] is equal to 2 and (((yCb/SubHeightC+yDm)»3)«3) is equal to yCb/SubHeightC+yDm, the following ordered steps apply:
a. The filtering process for chroma block edges as specified in clause 8.6.2.6.5 is invoked with the chroma picture sample array recPictureCb, the location of the chroma coding block (xCb/SubWidthC, yCb/SubHeightC), the chroma location of the block (xDk, yDm), a variable edgeType set equal to EDGE_HOR and a variable cQpPicOffset set equal to pps_cb_qp_offset as inputs, and the modified chroma picture sample array recPictureCb as output.
b. The filtering process for chroma block edges as specified in clause 8.6.2.6.5 is invoked with the chroma picture sample array recPictureCr, the location of the chroma coding block (xCb/SubWidthC, yCb/SubHeightC), the chroma location of the block (xDk, yDm), a variable edgeType set equal to EDGE_HOR and a variable cQpPicOffset set equal to pps_cr_qp_offset as inputs, and the modified chroma picture sample array recPictureCr as output.

When treeType is equal to DUAL_TREE_CHROMA, the filtering process for edges in the two chroma coding blocks of the current coding unit consists of the following ordered steps:

1. The variable yN is set equal to Max(0, (nCbH/8)−1) and xN is set equal to (nCbW/4)−1.
2. For yDm equal to m«3 with m=0.yN and xDk equal to k«2 with k=0.xN, the following applies:
When bS[xDk][yDm] is greater than 0, the following ordered steps apply:
a. The decision process for block edges as specified in clause 8.6.2.6.3 is invoked with treeType, the picture sample array recPicture set equal to the chroma picture sample array recPictureCb, the location of the chroma coding block (xCb, yCb), the location of the chroma block (xDk, yDm), a variable edgeType set equal to EDGE_HOR, the boundary filtering strength bS[xDk][yDm], and the bit depth bD set equal to BitDepthC as inputs, and the decisions dE, dEp and dEq, and the variable tC as outputs.
b. The filtering process for block edges as specified in clause 8.6.2.6.4 is invoked with the picture sample array recPicture set equal to the chroma picture sample array recPictureCb, the location of the chroma coding block (xCb, yCb), the chroma location of the block (xDk, yDm), a variable edgeType set equal to EDGE_HOR, the decisions dE, dEp and dEq, and the variable tC as inputs, and the modified chroma picture sample array recPictureCb as output. c. The filtering process for block edges as specified in clause 8.6.2.6.4 is invoked with the picture sample array recPicture set equal to the chroma picture sample array recPictureCr, the location of the chroma coding block (xCb, yCb), the chroma location of the block (xDk, yDm), a variable edgeType set equal to EDGE_HOR, the decisions dE, dEp and dEq, and the variable tC as inputs, and the modified chroma picture sample array recPictureCr as output.

### 8.6.2.6.3 Decision Process for Block Edges

Inputs to this Process are:
a variable treeType specifying whether a single tree (SINGLE_TREE) or a dual tree is used to partition the CTUs and, when a dual tree is used, whether the luma (DUAL_TREE_LUMA) or chroma components (DUAL_TREE_CHROMA) are currently processed,
a picture sample array recPicture,
a location (xCb, yCb) specifying the top-left sample of the current coding block relative to the top-left sample of the current picture,
a location (xBl, yBl) specifying the top-left sample of the current block relative to the top-left sample of the current coding block,
a variable edgeType specifying whether a vertical (EDGE VER) or a horizontal (EDGE HOR) edge is filtered,
a variable bS specifying the boundary filtering strength,
a variable bD specifying the bit depth of the current component.
   Outputs of this Process are:
the variables dE, dEp and dEq containing decisions,
the variable tC.

If edgeType is equal to EDGE_VER, the sample values pi,k and qi,k with i=0.3 and k=0 and 3 are derived as follows:

$$q i , k = recPictureL [ xCb + xBl + i ] [ y Cb + yBl + k ] \qquad ( 8 \; 867 )$$

$$pi , k = recPictureL [ xCb + xBl - i - 1 ] [ y Cb + yBl + k ] . \qquad ( 8 \; 868 )$$

Otherwise (edgeType is equal to EDGE HOR), the sample values pi,k and qi,k with i=0.3 and k=0 and 3 are derived as follows:

$$q i , k = recPicture [ xCb + xBl + k ] [ yCb + yBl + i ] \qquad ( 8 \; 869 )$$

$$pi , k = recPicture [ xCb + xBl + k ] [ yCb + yBl - i - 1 ] . \qquad ( 8 \; 870 )$$

The variable qpOffset is derived as follows:
If sps_ladf enabled_flag is equal to 1 and treeType is equal to SINGLE_TREE or DUAL_TREE_LUMA, the following applies:
The variable lumaLevel of the reconstructed luma level is derived as follow:
lumaLevel=((p0,0+p0,3+q0,0+q0,3)2), (8 871).
The variable qpOffset is set equal to sps_ladf_lowest_interval_qp_offset and modified as follows:

```
for( i = 0; i < sps_num_ladf_intervals_minus2 + 1; i++ ) {
  if( lumaLevel > SpsLadfIntervalLowerBound[ i + 1 ] )
    qpOffset = sps_ladf_qp_offset[ i ] (8 872)
  else
    break
}
```

Otherwise (treeType is equal to DUAL_TREE_CHROMA), qpOffset is set equal to 0.

The variables QpQ and QpP are derived as follows:
If treeType is equal to SINGLE_TREE or DUAL_TREE_LUMA, QpQ and QpP are set equal to the QpY values of the coding units which include the coding blocks containing the sample q0,0 and p0,0, respectively.
Otherwise (treeType is equal to DUAL_TREE_CHROMA), QpQ and QpP are set equal to the QpC values of the coding units which include the coding blocks containing the sample q0,0 and p0,0, respectively.

The variable qP is derived as follows:

$$q P = ( ( Q p Q + Q p P + 1 ) ≫ 1 ) + qpOffset . \qquad ( 8873 )$$

The value of the variable β′ is determined as specified in Table 8 18 based on the quantization parameter Q derived as follows:

$$Q = Clip 3 ( 0 , 63 , q P + ( tile\_group \_beta \_offset \_div2 << 1 ) ) \qquad ( 8 \; 874 )$$

where tile_group_beta_offset div2 is the value of the syntax element tile_group_beta_offset_div2 for the tile group that contains sample q0,0.

The variable D is derived as follows:

$$β = {β}^{′} * ( 1 << ( bD - 8 ) ) . \qquad ( 8875 )$$

The value of the variable tC′ is determined as specified in Table 8 18 based on the quantization parameter Q derived as follows:

$$Q = Clip 3 ( 0 , 65 , qP + 2 * ( b S - 1 ) + ( tile\_group \_tc \_offset \_div2 << 1 ) ) \qquad ( 8876 )$$

where tile_group_tc_offset_div2 is the value of the syntax element tile_group tc_offset_div2 for the tile group that contains sample q0,0.

The variable tC is derived as follows:

$$t C = {tC}^{′} * ( 1 << ( bD - 8 ) ) . \qquad ( 8877 )$$

Depending on the value of edgeType, the following applies:
If edgeType is equal to EDGE_VER, the following ordered steps apply:
1. The variables dpq0, dpq3, dp, dq and d are derived as follows:

$$d p 0 = Abs ( p 2 , 0 - 2 * p 1 , 0 + p 0 , 0 ) \qquad ( 8878 )$$

$$dp 3 = Abs ( p 2 , 3 - 2 * p 1 , 3 + p 0 , 3 ) \qquad ( 887 \; 9 )$$

$$dq 0 = Abs ( q 2 , 0 - 2 * q 1 , 0 + q 0 , 0 ) \qquad ( 888 \; 0 )$$

$$dq 3 = Abs ( q 2 , 3 - 2 * q 1 , 3 + q 0 , 3 ) \qquad ( 888 \; 1 )$$

$$dpq 0 = d p 0 + dq 0 \qquad ( 888 \; 2 )$$

$$dpq 3 = dp 3 + dq 3 \qquad ( 888 \; 3 )$$

$$dp = d p 0 + dp 3 \qquad ( 888 \; 4 )$$

$$dq = d q 0 + dq 3 \qquad ( 888 \; 5 )$$

$$d = dp q 0 + dpq 3. \qquad ( 888 \; 6 )$$

2. The variables dE, dEp and dEq are set equal to 0.
3. When d is less than D, the following ordered steps apply:
a. The variable dpq is set equal to 2*dpq0.
b. For the sample location (xCb+xBl, yCb+yBl), the decision process for a sample as specified in clause 8.6.2.6.6 is invoked with sample values p0,0, p3,0, q0,0, and q3,0, the variables dpq, D and tC as inputs, and the output is assigned to the decision dSam0.
c. The variable dpq is set equal to 2*dpq3.
d. For the sample location (xCb+xBl, yCb+yBl+3), the decision process for a sample as specified in clause 8.6.2.6.6 is invoked with sample values p0,3, p3,3, q0,3, and q3,3, the variables dpq, D and tC as inputs, and the output is assigned to the decision dSam3.
e. The variable dE is set equal to 1.
f. When dSam0 is equal to 1 and dSam3 is equal to 1, the variable dE is set equal to 2.
g. When dp is less than (β+(β»1))»3, the variable dEp is set equal to 1.
h. When dq is less than (β+(β»1))»3, the variable dEq is set equal to 1.
Otherwise (edgeType is equal to EDGE_HOR), the following ordered steps apply:
1. The variables dpq0, dpq3, dp, dq and d are derived as follows:

$$d p 0 = Abs ( p 2 , 0 - 2 * p 1 , 0 + p 0 , 0 ) \qquad ( 8887 )$$

$$dp 3 = Abs ( p 2 , 3 - 2 * p 1 , 3 + p 0 , 3 ) \qquad ( 888 \; 8 )$$

$$dq 0 = Abs ( q 2 , 0 - 2 * q 1 , 0 + q 0 , 0 ) \qquad ( 888 \; 9 )$$

$$dq 3 = Abs ( q 2 , 3 - 2 * q 1 , 3 + q 0 , 3 ) \qquad ( 889 \; 0 )$$

$$dpq 0 = d p 0 + dq 0 \qquad ( 889 \; 1 )$$

$$dpq 3 = dp 3 + dq 3 \qquad ( 889 \; 2 )$$

$$dp = d p 0 + dp 3 \qquad ( 889 \; 3 )$$

$$dq = d q 0 + dq 3 \qquad ( 889 \; 4 )$$

$$d = dp q 0 + dpq 3 . \qquad ( 889 \; 5 )$$

2. The variables dE, dEp and dEq are set equal to 0.
3. When d is less than D, the following ordered steps apply:
a. The variable dpq is set equal to 2*dpq0.
b. For the sample location (xCb+xBl, yCb+yBl), the decision process for a sample as specified in clause 8.6.2.6.6 is invoked with sample values p0,0, p3,0, q0,0 and q3,0, the variables dpq, D and tC as inputs, and the output is assigned to the decision dSam0.
c. The variable dpq is set equal to 2*dpq3.
d. For the sample location (xCb+xBl+3, yCb+yBl), the decision process for a sample as specified in clause 8.6.2.6.6 is invoked with sample values p0,3, p3,3, q0,3 and q3,3, the variables dpq, D and tC as inputs, and the output is assigned to the decision dSam3.
e. The variable dE is set equal to 1.
f. When dSam0 is equal to 1 and dSam3 is equal to 1, the variable dE is set equal to 2.
g. When dp is less than (β+(β»1))»3, the variable dEp is set equal to 1.
h. When dq is less than (β+(β»1))»3, the variable dEq is set equal to 1.

TABLE 8
18 - Derivation of threshold variables β′ and tC′ from input Q

| | | | | | | | | | | | | | | | | | |
|---|---|---|---|---|---|---|---|---|---|---|---|---|---|---|---|---|---|
| Q | 0 | 1 | 2 | 3 | 4 | 5 | 6 | 7 | 8 | 9 | 10 | 11 | 12 | 13 | 14 | 15 | 16 |
| β′ | 0 | 0 | 0 | 0 | 0 | 0 | 0 | 0 | 0 | 0 | 0 | 0 | 0 | 0 | 0 | 0 | 6 |
| tC′ | 0 | 0 | 0 | 0 | 0 | 0 | 0 | 0 | 0 | 0 | 0 | 0 | 0 | 0 | 0 | 0 | 0 |
| Q | 17 | 18 | 19 | 20 | 21 | 22 | 23 | 24 | 25 | 26 | 27 | 28 | 29 | 30 | 31 | 32 | 33 |
| β′ | 7 | 8 | 9 | 10 | 11 | 12 | 13 | 14 | 15 | 16 | 17 | 18 | 20 | 22 | 24 | 26 | 28 |
| tC′ | 0 | 1 | 1 | 1 | 1 | 1 | 1 | 1 | 1 | 1 | 2 | 2 | 2 | 2 | 3 | 3 | 3 |
| Q | 34 | 35 | 36 | 37 | 38 | 39 | 40 | 41 | 42 | 43 | 44 | 45 | 46 | 47 | 48 | 49 | 50 |
| β′ | 30 | 32 | 34 | 36 | 38 | 40 | 42 | 44 | 46 | 48 | 50 | 52 | 54 | 56 | 58 | 60 | 62 |
| tC′ | 3 | 4 | 4 | 4 | 5 | 5 | 6 | 6 | 7 | 8 | 9 | 10 | 11 | 13 | 14 | 16 | 18 |
| Q | 51 | 52 | 53 | 54 | 55 | 56 | 57 | 58 | 59 | 60 | 61 | 62 | 63 | 64 | 65 | | |
| β′ | 64 | 66 | 68 | 70 | 72 | 74 | 76 | 78 | 80 | 82 | 84 | 86 | 88 | — | — | | |
| tC′ | 20 | 22 | 25 | 28 | 31 | 35 | 39 | 44 | 50 | 56 | 63 | 70 | 79 | 88 | 99 | | |

### 8.6.2.6.4 Filtering Process for Block Edges

Inputs to this Process are:
a picture sample array recPicture,
a location (xCb, yCb) specifying the top-left sample of the current coding block relative to the top-left sample of the current picture,
a location (xBl, yBl) specifying the top-left sample of the current block relative to the top-left sample of the current coding block,
a variable edgeType specifying whether a vertical (EDGE VER) or a horizontal (EDGE HOR) edge is filtered,
the variables dE, dEp and dEq containing decisions,
the variable tC.

Output of this process is the modified picture sample array recPicture.

Depending on the value of edgeType, the following applies:
If edgeType is equal to EDGE_VER, the following ordered steps apply:

1. The sample values pi,k and qi,k with i=0.3 and k=0.3 are derived as follows:

$$q i , k = r e c P i c t u r e L [ x C b + xB 1 + i ] [ y C b + yB 1 + k ] \qquad ( 8896 )$$

$$pi , k = recPictureL [ x C b + xB 1 - i - 1 ] [ y C b + yB 1 + k ] . \qquad ( 889 \; 7 )$$

2. When dE is not equal to 0, for each sample location (xCb+xBl, yCb+yBl+k), k=0.3, the following ordered steps apply:
a. The filtering process for a sample as specified in clause 8.6.2.6.7 is invoked with the sample values pi,k, qi,k with i=0.3, the locations (xPi, yPi) set equal to (xCb+xBl−i−1, yCb+yBl+k) and (xQi, yQi) set equal to (xCb+xBl+i, yCb+yBl+k) with i=0.2, the decision dE, the variables dEp and dEq and the variable tC as inputs, and the number of filtered samples nDp and nDq from each side of the block boundary and the filtered sample values pi‘ and gi’ as outputs.
b. When nDp is greater than 0, the filtered sample values pi′ with i=0.nDp−1 replace the corresponding samples inside the sample array recPicture as follows:

$$r e c P i c t u r e [ x C b + x B 1 - i - 1 ] [ y C b + y B 1 + k ] = {pi}^{′} . \qquad ( 8898 )$$

c. When nDq is greater than 0, the filtered sample values qi′ with j=0.nDq−1 replace the corresponding samples inside the sample array recPicture as follows:

$$r e c P i c t u r e [ x C b + xB 1 + j ] [ y C b + yB 1 + k ] = {qj}^{′} . \qquad ( 8899 )$$

Otherwise (edgeType is equal to EDGE_HOR), the following ordered steps apply:
1. The sample values pi,k and qi,k with i=0.3 and k=0.3 are derived as follows:

$$q i , k = r e c P i c t u r e L [ x C b + xB 1 + k ] [ y C b + yB 1 + i ] \qquad ( 8900 )$$

$$pi , k = recPictureL [ x C b + xB 1 + k ] [ y C b + yB 1 - i - 1 ] . \qquad ( 8901 )$$

2. When dE is not equal to 0, for each sample location (xCb+xBl+k, yCb+yBl), k=0.3, the following ordered steps apply:
a. The filtering process for a sample as specified in clause 8.6.2.6.7 is invoked with the sample values pi,k, qi,k with i=0.3, the locations (xPi, yPi) set equal to (xCb+xBl+k, yCb+yBl-i−1) and (xQi, yQi) set equal to (xCb+xBl+k, yCb+yBl+i) with i=0.2, the decision dE, the variables dEp and dEq, and the variable tC as inputs, and the number of filtered samples nDp and nDq from each side of the block boundary and the filtered sample values pi‘ and gi’ as outputs.
b. When nDp is greater than 0, the filtered sample values pi′ with i=0.nDp−1 replace the corresponding samples inside the sample array recPicture as follows:

$$r e c P i c t u r e [ x C b + xB 1 + k ] [ y C b + y B 1 - i - 1 ] = {pi}^{′} . \qquad ( 8902 )$$

c. When nDq is greater than 0, the filtered sample values gi′ with j=0.nDq−1 replace the corresponding samples inside the sample array recPicture as follows:

$$r e c P i c t u r e [ x C b + xB 1 + k ] [ y C b + y B 1 + j ] = {qj}^{′} . \qquad ( 8903 )$$

### 8.6.2.6.5 Filtering Process for Chroma Block Edges

This process is only invoked when ChromaArrayType is not equal to 0.

Inputs to this Process are:
a chroma picture sample array s′,
a chroma location (xCb, yCb) specifying the top-left sample of the current chroma coding block relative to the top-left chroma sample of the current picture,
a chroma location (xBl, yBl) specifying the top-left sample of the current chroma block relative to the top-left sample of the current chroma coding block,
a variable edgeType specifying whether a vertical (EDGE VER) or a horizontal (EDGE HOR) edge is filtered,
a variable cQpPicOffset specifying the picture-level chroma quantization parameter offset.

Output of this process is the modified chroma picture sample array s′.

If edgeType is equal to EDGE_VER, the values pi and qi with i=0.1 and k=0.3 are derived as follows:

$$q i , k = {s}^{′} [ xCb + xB 1 + i ] [ y C b + yB 1 + k ] \qquad ( 8904 )$$

$$pi , k = {s}^{′} [ xCb + xB 1 - i - 1 ] [ yCb + yB 1 + k ] . \qquad ( 890 \; 5 )$$

Otherwise (edgeType is equal to EDGE HOR), the sample values pi and qi with i=0.1 and k=0.3 are derived as follows:

$$q i , k = {s}^{′} [ xCb + xB 1 + k ] [ y C b + yB 1 + i ] \qquad ( 8906 )$$

$$pi , k = {s}^{′} [ xCb + xB 1 + k ] [ y C b + yB 1 - i - 1 ] . \qquad ( 890 \; 7 )$$

The variables QpQ and QpP are set equal to the QpY values of the coding units which include the coding blocks containing the sample q0,0 and p0,0, respectively.

If ChromaArrayType is equal to 1, the variable QpC is determined as specified in Table 8 15 based on the index qPi derived as follows:

$$q P i = ( ( Q p Q + Q p P + 1 ) >> 1 ) + cQpPicOffset . \qquad ( 8908 )$$

Otherwise (ChromaArrayType is greater than 1), the variable QpC is set equal to Min(qPi, 63).

NOTE—The variable cQpPicOffset provides an adjustment for the value of pps_cb_qp_offset or pps_cr_qp_offset, according to whether the filtered chroma component is the Cb or Cr component. However, to avoid the need to vary the amount of the adjustment within the picture, the filtering process does not include an adjustment for the value of tile_group_cb_qp_offset or tilegroup_crqp_offset.

The value of the variable tC′ is determined as specified in Table 8 18 based on the chroma quantization parameter Q derived as follows:

$$Q = Clip 3 ( 0 , 65 , QpC + 2 + ( tile\_group \_tc \_offset \_div2 << 1 ) ) \qquad ( 8909 )$$

where tile_group_tc_offset_div2 is the value of the syntax element tile_group tc_offset_div2 for the tile group that contains sample q0,0.

The variable tC is derived as follows:

$$tC = {tC}^{′} * ( 1 << ( BitDepthC - 8 ) ) . \qquad ( 8 \; 910 )$$

Depending on the Value of edgeType, the Following Applies:
If edgeType is equal to EDGE_VER, for each sample location (xCb+xBl, yCb+yBl+k), k=0.3, the following ordered steps apply:
1. The filtering process for a chroma sample as specified in clause 8.6.2.6.8 is invoked with the sample values pi,k, qi,k, with i=0.1, the locations (xCb+xBl−1, yCb+yBl+k) and (xCb+xBl, yCb+yBl+k) and the variable tC as inputs, and the filtered sample values p0′ and q0′ as outputs.
2. The filtered sample values p0′ and q0′ replace the corresponding samples inside the sample array s′ as follows:

$${s}^{′} [ xCb + xBl ] [ yCb + yBl + k ] = q {0}^{′} \qquad ( 8911 )$$

$${s}^{′} [ xCb + xBl - 1 ] [ yCb + yBl + k ] = p {0}^{′} . \qquad ( 8912 )$$

Otherwise (edgeType is equal to EDGE_HOR), for each sample location (xCb+xBl+k, yCb+yBl), k =0.3, the following ordered steps apply:
1. The filtering process for a chroma sample as specified in clause 8.6.2.6.8 is invoked with the sample values pi,k, qi,k, with i=0.1, the locations (xCb+xBl+k, yCb+yBl−1) and (xCb+xBl+k, yCb+yBl) and the variable tC as inputs, and the filtered sample values p0′ and q0′ as outputs.
2. The filtered sample values p0′ and q0′ replace the corresponding samples inside the sample array s′ as follows:

$${s}^{′} [ xCb + xBl + k ] [ yCb + yBl ] = q {0}^{′} \qquad ( 8913 )$$

$${s}^{′} [ xCb + xBl + k ] [ yCb + yBl - 1 ] = p {0}^{′} . \qquad ( 8914 )$$

### 8.6.2.6.6 Decision Process for a Sample

Inputs to this Process are:
the sample values p0, p3, q0 and q3,
the variables dpq, D and tC.

Output of this process is the variable dSam containing a decision.

The variable dSam is specified as follows:
If dpq is less than (β»2),Abs(p3-p0)+Abs(q0-q3)is less than (β»3)and Abs(p0-q0) is less than (5*tC+1)»1, dSam is set equal to 1.
Otherwise, dSam is set equal to 0.

### 8.6.2.6.7 Filtering Process for a Sample

Inputs to this Process are:
the sample values pi and qi with i=0.3,
the locations of pi and qi, (xPi, yPi) and (xQi, yQi) with i=0.2,
a variable dE,
the variables dEp and dEq containing decisions to filter samples p1 and q1, respectively,
a variable tC.
   Outputs of this Process are:
the number of filtered samples nDp and nDq,
the filtered sample values pi‘ and gi’ with i=0.nDp−1,j=0.nDq−1.

Depending on the value of dE, the following applies:
If the variable dE is equal to 2, nDp and nDq are both set equal to 3 and the following strong filtering applies:

$$p {0}^{′} = Clip 3 ( p 0 - 2 * tC , p 0 + 2 * tC , ( p 2 + 2 * p 1 + 2 * p 0 + 2 * q 0 + q 1 + 4 ) >> 3 ) \qquad ( 8915 )$$

$$p {1}^{′} = Clip 3 ( p 1 - 2 * tC , p 1 + 2 * tC , ( p 2 + p 1 + p 0 + q 0 + 2 ) >> 2 ) \qquad ( 8916 )$$

$$p {2}^{′} = Clip \text{} 3 \text{} ( p 2 - 2 * tC , p 2 + 2 * tC , ( 2 * p 3 + 3 * p 2 + p 1 + p 0 + q 0 + 4 ) >> 3 ) \qquad ( 8917 )$$

$$q {0}^{′} = Clip 3 \text{} ( q 0 - 2 * tC , q 0 + 2 * tC , ( p 1 + 2 * p 0 + 2 * q 0 + 2 * q 1 + q 2 + 4 ) >> 3 ) \qquad ( 8918 )$$

$$q {1}^{′} = Clip 3 ( q 1 - 2 * tC , q 1 + 2 * tC , ( p 0 + q 0 + q 1 + q 2 + 2 ) >> 2 ) \qquad ( 8919 )$$

$$q {2}^{′} = Clip \text{} 3 \text{} ( q 2 - 2 * tC , q 2 + 2 * tC , ( p 0 + q 0 + q 1 + 3 * q 2 + 2 * q 3 + 4 ) >> 3 ) . \qquad ( 892 \; 0 )$$

Otherwise, nDp and nDq are set both equal to 0 and the following weak filtering applies:
The following applies:

$$Δ = ( 9 * ( q 0 - p 0 ) - 3 * ( q 1 - p 1 ) + 8 ) >> 4 \qquad ( 892 \; 1 )$$

When Abs(A) is less than tC * 10, the following ordered steps apply:
The filtered sample values p0′ and q0′ are specified as follows:

$$Δ = Clip 3 ( - t C , tC , Δ ) \qquad ( 8922 )$$

$$p {0}^{′} = Clip 1 Y ( p 0 + Δ ) \qquad ( 8923 )$$

$$q {0}^{′} = Clip 1 Y ( q 0 - Δ ) . \qquad ( 892 \; 4 )$$

When dEp is equal to 1, the filtered sample value p′ is specified as follows:

$$Δ p = Clip 3 ( - ( tC >> 1 ) , tC >> 1 , ( ( ( p 2 + p 0 + 1 ) >> 1 ) - p 1 + Δ ) >> 1 ) \qquad ( 8925 )$$

$$p {1}^{′} = Clip 1 Y ( p 1 + Δ p ) . \qquad ( 892 \; 6 )$$

When dEq is equal to 1, the filtered sample value q1′ is specified as follows:

$$Δ q = Clip 3 ( - ( tC >> 1 ) , tC >> 1 , ( ( ( q 2 + q 0 + 1 ) >> 1 ) - q 1 - Δ ) >> 1 ) \qquad ( 8927 )$$

$$q {1}^{′} = Clip 1 Y ( q 1 + Δ q ) . \qquad ( 8928 )$$

nDp is set equal to dEp+1 and nDq is set equal to dEq+1.

When nDp is greater than 0 and one or more of the following conditions are true, nDp is set equal to 0:
pcm_loop_filter_disabled flag is equal to 1 and pcm_flag[xPO][yPO] is equal to 1.
cu_transquant_bypass_flag of the coding unit that includes the coding block containing the sample p0 is equal to 1.

When nDq is greater than 0 and one or more of the following conditions are true, nDq is set equal to 0:
pcm_loop_filter_disabled flag is equal to 1 and pcm_flag[xQO][yQO] is equal to 1.
cu_transquant_bypass_flag of the coding unit that includes the coding block containing the sample q0 is equal to 1.

### 8.6.2.6.8 Filtering Process for a Chroma Sample

This process is only invoked when ChromaArrayType is not equal to 0.

Inputs to this Process are:
the chroma sample values pi and qi with i=0.1,
the chroma locations of p0 and q0, (xPO, yPO) and (xQO, yQO),
a variable tC.

Outputs of this process are the filtered sample values p0′ and q0′.

The filtered sample values p0′ and q0′ are derived as follows:

$$Δ = Clip 3 ( - tC , tC , ( ( ( ( q 0 - p 0 ) << 2 ) + p 1 - q 1 + 4 ) >> 3 ) ) \qquad ( 8929 )$$

$$p {0}^{′} = Clip 1 C ( p 0 + Δ ) \qquad ( 893 \; 0 )$$

$$q {0}^{′} = Clip 1 C ( q 0 - Δ ) . \qquad ( 8931 )$$

When one or more of the following conditions are true, the filtered sample value, p0′ is substituted by the corresponding input sample value p0:
pcm_loop_filter_disabled flag is equal to 1 and pcm_flag[xPO * SubWidthC][yPO * SubHeightC] is equal to 1.
cu_transquant_bypass_flag of the coding unit that includes the coding block containing the sample p0 is equal to 1.

When one or more of the following conditions are true, the filtered sample value, q0′ is substituted by the corresponding input sample value q0:
pcm_loop_filter disabled flag is equal to 1 and pcm_flag[xQO * SubWidthC][yQO * SubHeightC] is equal to 1.
cu_transquant_bypass_flag of the coding unit that includes the coding block containing the sample q0 is equal to 1.

### 8.6.3 Sample Adaptive Offset Process

### 8.6.3.1 General

Inputs to this process are the reconstructed picture sample array prior to sample adaptive offset recPictureL and, when ChromaArrayType is not equal to 0, the arrays recPictureCb and recPictureCr.

Outputs of this process are the modified reconstructed picture sample array after sample adaptive offset saoPictureL and, when ChromaArrayType is not equal to 0, the arrays saoPictureCb and saoPictureCr.

This process is performed on a CTB basis after the completion of the deblocking filter process for the decoded picture.

The sample values in the modified reconstructed picture sample array saoPictureL and, when ChromaArrayType is not equal to 0, the arrays saoPictureCb and saoPictureCr are initially set equal to the sample values in the reconstructed picture sample array recPictureL and, when ChromaArrayType is not equal to 0, the arrays recPictureCb and recPictureCr, respectively.

For every CTU with CTB location (rx, ry), where rx=0.PicWidthInCtbsY−1 and ry=0.PicHeightInCtbsY
1, the following applies:
When tile_group_sao_luma flag of the current tile group is equal to 1, the CTB modification process as specified in clause 8.6.3.2 is invoked with recPicture set equal to recPictureL, cIdx set equal to 0, (rx, ry), and both nCtbSw and nCtbSh set equal to CtbSizeY as inputs, and the modified luma picture sample array saoPictureL as output.
When ChromaArrayType is not equal to 0 and tile_group_sao_chroma flag of the current tile group is equal to 1, the CTB modification process as specified in clause 8.6.3.2 is invoked with recPicture set equal to recPictureCb, cIdx set equal to 1, (rx, ry), nCtbSw set equal to (1 CtbLog2SizeY)/SubWidthC and nCtbSh set equal to (1 CtbLog2SizeY)/SubHeightC as inputs, and the modified chroma picture sample array saoPictureCb as output.
When ChromaArrayType is not equal to 0 and tile_group_sao_chroma flag of the current tile group is equal to 1, the CTB modification process as specified in clause 8.6.3.2 is invoked with recPicture set equal to recPictureCr, cIdx set equal to 2, (rx, ry), nCtbSw set equal to (1«CtbLog2SizeY)/SubWidthC and nCtbSh set equal to (1«CtbLog2SizeY)/SubHeightC as inputs, and the modified chroma picture sample array saoPictureCr as output.

### 8.6.3.2 CTB Modification Process

Inputs to this Process are:
the picture sample array recPicture for the colour component cIdx,
a variable cIdx specifying the colour component index,
a pair of variables (rx, ry) specifying the CTB location,
the CTB width nCtbSw and height nCtbSh.

Output of this process is a modified picture sample array saoPicture for the colour component cIdx.

The variable bitDepth is derived as follows:
If cIdx is equal to 0, bitDepth is set equal to BitDepthY.
Otherwise, bitDepth is set equal to BitDepthC.

The location (xCtb, yCtb), specifying the top-left sample of the current CTB for the colour component cIdx relative to the top-left sample of the current picture component cIdx, is derived as follows:

$$( xCtb , yCtb ) = ( rx * nCtbSw , ry * nCtbSh ) . \qquad ( 8932 )$$

The sample locations inside the current CTB are derived as follows:

$$( xSi , ySj ) = ( xCtb + i , yCtb + j ) \qquad ( 893 \; 3 )$$

$$( xYi , yYj ) = ( cIdx == 0 ) ? ( xSi , ySj ) : ( xSi * SubWidthC , ySj * SubHeightC ) . \qquad ( 893 \; 4 )$$

For all sample locations (xSi, ySj) and (xYi, yYj) with i=0.nCtbSw−1 and j=0.nCtbSh-1, depending on the values of pcm_loop_filter_disabled flag, pcm_flag[xYi][yYj] and cu transquant_bypass_flag of the coding unit which includes the coding block covering recPicture[xSi][ySj], the following applies:
If one or more of the following conditions are true, saoPicture[xSi][ySj] is not modified:
pcm_loop_filter_disabled flag and pcm_flag[xYi][yYj] are both equal to 1.
cu_transquant_bypass_flag is equal to 1.
SaoTypeIdx[cIdx][rx][ry] is equal to 0. [Ed. (BB): Modify highlighted sections prending on future decision transform/quantizaion bypass.]
Otherwise, if SaoTypeIdx[cIdx][rx][ry] is equal to 2, the following ordered steps apply:

1. The values of hPos[k] and vPos[k] for k=0.1 are specified in Table 8 19 based on SaoEoClass[cIdx][rx][ry].
2. The variable edgeldx is derived as follows:
The modified sample locations (xSik′, ySjk′ ) and (xYik′ yYjk′) are derived as follows: (xSik′, ySjk′)=(xSi+hPos[k], ySj+vPos[k])(8 935)

$$( {xSik}^{′} , {ySjk}^{′} ) = ( xSi + hPos [ k ] , ySj + vPos [ k ] ) \qquad ( 8935 )$$

$$( {xYik}^{′} , {yYjk}^{′} ) = ( cIdx == 0 ) ? ( {xSik}^{′} , {ySjk}^{′} ) \text{} : ( {xSik}^{′} * SubWidthC , {ySjk}^{′} * SubHeightC ) . \qquad ( 8936 )$$

If one or more of the following conditions for all sample locations (xSik′, ySjk′) and (xYik′, yYjk′ ) with k=0.1 are true, edgeldx is set equal to 0:
The sample at location (xSik′, ySjk′) is outside the picture boundaries.
The sample at location (xSik′, ySjk′) belongs to a different tile group and one of the following two conditions is true:
MinTbAddrZs[xYik′»MinTbLog2SizeY][yYjk′»MinTbLog2SizeY] is less than MinTbAddrZs[xYi»MinTbLog2SizeY][yYj MinTbLog2SizeY] and tile_group_loop_filter_across tilegroups_enabled flag in the tile group which the sample recPicture[xSi][ySj] belongs to is equal to 0.
MinTbAddrZs[xYi»MinTbLog2SizeY][yYj MinTbLog2SizeY] is less than MinTbAddrZs[xYik′»MinTbLog2SizeY][yYjk′ MinTbLog2SizeY] and tile_group_loop_filter_across tilegroups_enabled flag in the tile group which the sample recPicture[xSik′][ySjk′] belongs to is equal to 0.
loop_filter_across_tiles_enabled_flag is equal to 0 and the sample at location (xSik′, ySjk′ ) belongs to a different tile.

[Ed. (BB): Modify highlighted sections when tiles without tile groups are incorporated]
Otherwise, edgeldx is derived as follows:
The following applies:

$$edgeIdx = 2 + Sign ( \text{} recPicture [ xSi ] [ ySj ] - recPicture [ xSi + hPos [ 0 ] ] [ ySj + v P o s [ 0 ] ] ) + Sign ( \text{} recPicture [ xSi ] [ ySj ] - recPicture [ xSi + hPos [ 1 ] ] [ ySj + vPos [ 1 ] ] ) . \qquad ( 893 \; 7 )$$

When edgeldx is equal to 0, 1, or 2, edgeldx is modified as follows:

$$edgeIdx = ( edgeIdx == 2 ) ? 0 : ( edgeIdx + 1 ) . \qquad ( 8938 )$$

3. The modified picture sample array saoPicture[xSi ][ySj ] is derived as follows:

$$saoPicture [ xSi ] [ ySj ] = Clip 3 ( 0 , ( 1 << bitDepth ) - 1 , recPicture [ xSi ] [ ySj ] + SaoOffsetVal [ cIdx ] [ rx ] [ ry ] [ edgeIdx ] ) . \qquad ( 893 \; 9 )$$

Otherwise (SaoTypeldx[cldx][rx][ry] is equal to 1), the following ordered steps apply:
1. The variable bandShift is set equal to bitDepth−5.
2. The variable saoLeftClass is set equal to sao_band_position[cldx][rx][ry].
3. The list bandTable is defined with 32 elements and all elements are initially set equal to 0. Then, four of its elements (indicating the starting position of bands for explicit offsets) are modified as follows: for(k=0; k<4; k++)

$$bandTable [ ( k + saoLeftClass ) \& 31 ] = k + 1. \qquad ( 8 \; 940 )$$

4. The variable bandldx is set equal to bandTable[recPicture[xSi][ySj] bandShift].
5. The modified picture sample array saoPicture[xSi][ySj] is derived as follows:

$$s a o P i c t u r e [ x S i ] [ y S j ] = C l i p 3 ( 0 , ( 1 ≪ bitDepth ) - 1 , recPicture [ xSi ] [ y S j ] + SaoOffsetVal [ cIdx ] [ rx ] [ ry ] [ bandIdx ] ) . \qquad ( 8 \; 941 )$$

TABLE 8
19 - Specification of hPos and vPos according
to the sample adaptive offset class

| SaoEoClass[ cIdx ][ rx ][ ry ] | | | | 0 1 2 3 |
|---|---|---|---|---|
| hPos[ 0 ] | −1 | 0 | −1 | 1 |
| hPos[ 1 ] | 1 | 0 | 1 | −1 |
| vPos[ 0 ] | 0 | −1 | −1 | −1 |
| vPos[ 1 ] | 0 | 1 | 1 | 1 |

### 2.7. OBMC in ECM

When OBMC is applied, top and left boundary pixels of a CU are refined using neighboring block′s motion information with a weighted prediction.

Conditions of not applying OBMC are as follows:
   | When OBMC is disabled at SPS level.
⊏ When current block has intra mode or IBC mode.
   | When current block applies LIC.
⊏ When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$$Inter {}_{predY}^{′} = \frac{( 128 - {w}_{1} ) \times {Inter}_{p r e d Y} + {w}_{1} \times {OBMC}_{p r e d Y}}{128}$$

$$PredY = \frac{( 4 - {w}_{0} ) \times FwdMap ( Inter {}_{predY}^{′} ) + {w}_{0} \times {Intra}_{predY}}{4} ,$$

where inter_{predY} represents the samples predicted by the motion of current block in the original domain, Intra_{predy} represents the samples predicted in the mapped domain, OBMC_{predY} represents the samples predicted by the motion of neighboring blocks in the original domain, and w₀ and w₁ are the weights.

### 2.8. Interweaved Prediction

To overcome the problems in sub-block based prediction, an interweaved prediction in video coding is proposed.

With interweaved prediction, a block is divided into sub-blocks with more than one dividing patterns. A dividing pattern is defined as the way to divide a block into sub-blocks, including the size of sub-blocks and the position of sub-blocks. For each dividing pattern, a corresponding prediction block may be generated by deriving motion information of each sub-block based on the dividing pattern. Therefore, even for one prediction direction, multiple prediction blocks may be generated by multiple dividing patterns. Alternatively, for each prediction direction, only a dividing pattern may be applied.

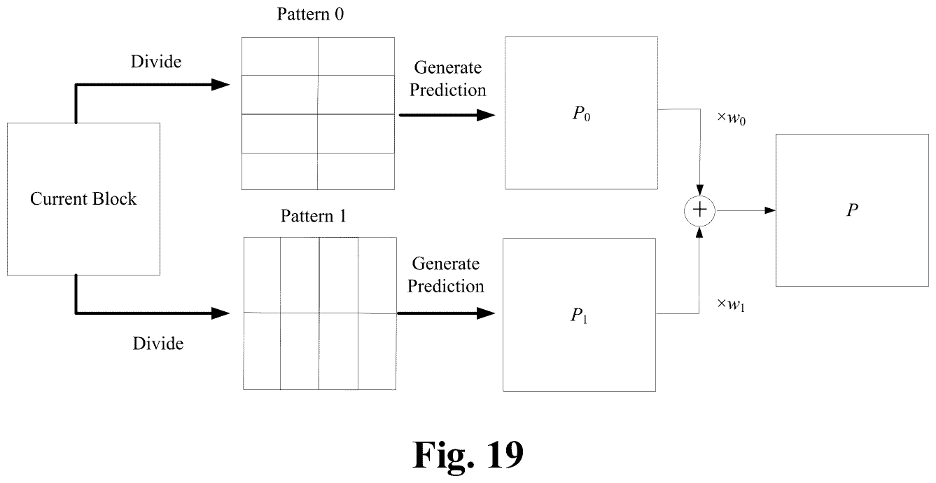

Suppose there are X dividing patterns, and X prediction blocks of the current block, denoted as P0, P1, . . . , PX-1 are generated by sub-block based prediction with the X dividing patterns. The final prediction of the current block, denoted as P, can be generated as

$$P ( x , y ) = \frac{{\sum }_{i = 0}^{X - 1} {w}_{i} ( x , y ) \times {P}_{i} ( x , y )}{{\sum }_{i = 0}^{X - 1} {w}_{i} ( x , y )} \qquad ( 15 )$$

where (x, y) is the coordinate of a pixel in the block and wᵢ(x, y) is the weighting value of Pi. Without losing generalization, it is supposed that

$${\sum }_{i = 0}^{X - 1} {w}_{i} ( x , y ) = ( 1 ≪ N )$$

wherein N is a non-negative value. FIG. 19 shows an example of interweaved prediction with two dividing patterns.

The detailed embodiments below should be considered as examples to explain general concepts. These embodiments should not be interpreted in a narrow way. Furthermore, these embodiments can be combined in any manner.

### Usage of Interweaved Prediction for Different Coding Tools

1. Interweaved prediction can be applied in one, some or all coding tools with sub-block based prediction. In one example, affine prediction applies interweaved prediction while other coding tools with sub-block based prediction such as ATMVP, STMVP, FRUC and BIO do not apply interweaved prediction. In another example, affine, ATMVP and STMVP apply interweaved prediction.

### Definitions of Dividing Patterns

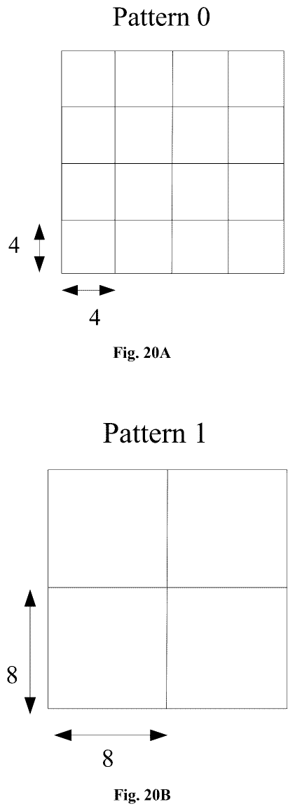

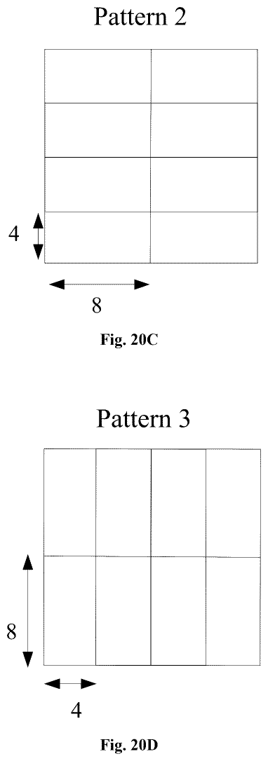

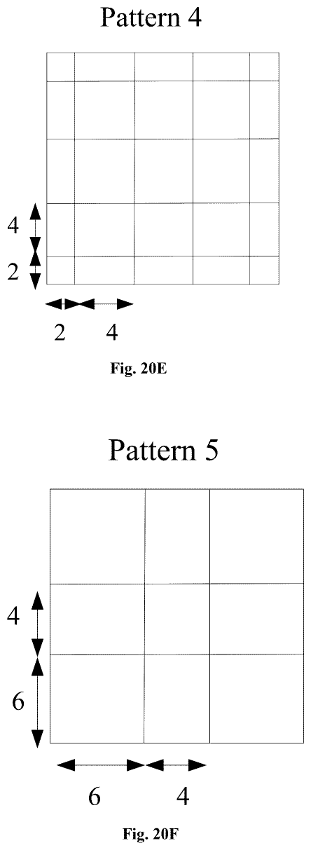

2. Dividing patterns can have different shapes, or sizes, or positions of sub-blocks. In one example, a dividing pattern may result in irregular sub-block sizes. FIG. 20A-FIG. 20G illustrate several exemplary dividing patterns for a 16×16 block. In FIG. 20A, the block is divided into 4×4 sub-blocks as in JEM; In FIG. 20B, the block is divided into 8×8 sub-blocks; In FIG. 20C and FIG. 20D, the block is divided into 8×4 sub-blocks and 4×8 sub-blocks, respectively; In FIG. 20E and FIG. 20F, the block is also divided into 4×4 sub-blocks but with different positions. The pixels at block boundaries which cannot be divided into an integral 4×4 sub-block can be divided in smaller sub-blocks with sizes like 2×4, 4×2 or 2×2 as shown in FIG. 20E, or they can be merged into adjacent 4×4 sub-blocks to form larger sub-blocks with sizes like 6×4, 4×6 or 6×6 as shown in FIG. 20F; In FIG. 20G the block is also divided into 8×8 sub-blocks but with different positions. The pixels at block boundaries which cannot be divided into an integral 8×8 sub-block can be divided in smaller sub-blocks with sizes like 8×4, 4×8 or 4×4.
3. The shapes and sizes of sub-blocks in sub-block based prediction can depend on the shape and/or size of the coding block and/or coded block information (e.g., it is affine or ATMVP mode).
   a. In one example, the sub-blocks are with the size 4×N (or 8×N and so on) when the current block is with the size M×N.
   b. In one example, the sub-blocks are with the size M×4 (or M×8 and so on) when the current block is with the size M×N.
   c. In one example, the sub-blocks are with the size A×B with A>B such as 8×4, when the current block is with the size M×N and M >N; otherwise, the sub-blocks are with the size B×A such as 4×8.
   d. In one example, suppose the current block is with the size M×N, then sub-blocks are with the size A xB when M×N <=T (or Min(M, N)<=T, or Max(M, N)<=T and so on) and sub-blocks are with the size CxD when M×N>T (or Min(M, N) >T, or Max(M, N) >T, and so on), where A<=C and B<=D. For example, if M×N<=256 sub-blocks are with the size 4×4; otherwise, sub-blocks are with the size 8×8.
      Enabling/disabling interweaved prediction and coding process of interweaved prediction
4. Whether to apply interweaved prediction depends on the inter-prediction direction.
   a. In one example, the interweaved prediction may be applied for bi-prediction but not for uniprediction.
   b. In one example, when multiple-hypothesis is applied, the interweaved prediction may be applied for one prediction direction when there are more than one reference blocks.
5. How to apply interweaved prediction depends on the inter-prediction direction.
   a. In one example, a bi-predicted block with sub-block based prediction is divided into sub-blocks with two different dividing patterns for two different reference lists. In one example, the block is divided into 4×8 sub-blocks as shown in FIG. 20D when predicted from reference list 0 (L0), but divided into 8×4 sub-blocks as shown in FIG. 20C when predicted from reference list 1 (L1).

And the final prediction P is calculated as

$$P ( x , y ) = \frac{{w}^{0} ( x , y ) \times {P}^{0} ( x , y ) + {w}^{1} ( x , y ) \times {P}^{1} ( x , y )}{{w}^{0} ( x , y ) + {w}^{1} ( x , y )} \qquad ( 16 )$$

where P0 and P1 are predictions from L0 and L1, respectively. w0 and w1 are weighting values for L0 and L1, respectively. Without losing generalization, it is supposed that w° (x, y) +wᵢ(x, y)=1N (wherein N is non-negative integer value).
   b. In one example, a uni-predicted block with sub-block based prediction is divided into sub-blocks with two or more different dividing patterns. For example, the prediction for list L (L=0 or 1) PL is calculated as

$${P}^{L} ( x , y ) = \frac{{\sum }_{i = 0}^{X L - 1} {w}_{i}^{L} ( x , y ) \times {P}_{i}^{L} ( x , y )}{{\sum }_{i = 0}^{X L - 1} {w}_{i}^{L} ( x , y )} \qquad ( 17 )$$

where XL is the number of dividing patterns for list L;

$${P}_{i}^{L} ( x , y )$$

is the prediction generated with the ith dividing pattern and wᵢ^{L}(x, y) is the weighting value of Pᵢ^{L}(x, y). For example, XL is 2. With the 0th dividing pattern, the block is divided into 4×8 sub-blocks as shown in FIG. 20D. With the ith dividing pattern, the block is divided into 8×4 sub-blocks as shown in FIG. 20C.
c. In one example, a bi-predicted block with sub-block based prediction is considered as a combination of two uni-predicted block from L0 and Li respectively. The prediction from each list can be derived as described in the above example. The final prediction P can be calculated as

$$P ( x , y ) = \frac{a * \frac{{\sum }_{i = 0}^{X 1 - 1} {w}_{i}^{0} ( x , y ) \times {P}_{i}^{0} ( x , y )}{{\sum }_{i = 0}^{X 1 - 1} {w}_{i}^{0} ( x , y )} + b * \frac{{\sum }_{i = 0}^{X 1 - 1} {w}_{i}^{1} ( x , y ) \times {P}_{i}^{1} ( x , y )}{{\sum }_{i = 0}^{X 1 - 1} {w}_{i}^{1} ( x , y )}}{a + b} \qquad ( 18 )$$

wherein parameters a and b are two additional weights applied to the two internal prediction blocks. In one example, a and b are both equal to 1.
   d. In one example, for a multiple hypothesis coded block, for each prediction direction (or reference picture list), there could be more than one prediction blocks generated by different dividing patterns. Multiple prediction blocks may be utilized to generate the final version with additional weights applied. In one example, the additional weights may be set to 1/M wherein M is the total number of generated prediction blocks.
6. Whether and how to apply interweaved prediction can be transmitted from the encoder to the decoder at sequence level, picture level, view level, slice level, Coding Tree Unit (CTU) (a. k. a. Largest Coding Unit (LCU) level, CU level, PU level or TU level or tile level or tile group level or region level which may contain multiple CUs/PUs/Tus/LCUs. The information can be signaled in Sequence Parameter Set (SPS), view parameter set (VPS), Picture Parameter Set (PPS), Slice Header (SH), picture header, sequence header, or tile level or tile group level, CTU (a. k. a. LCU), CU, PU, TU or the first block of a region.
   a. In one example, interweaved prediction applies to existing sub-block methods like ATMVP, STMVP, FRUC, BIO or affine implicitly. In this example, no additional signaling cost is needed at all.
   b. In another example, new sub-block merge candidates generated by interweaved prediction are inserted into merge list, e.g., interweaved prediction+ATMVP, interweaved prediction+STMVP, interweaved prediction+FRUC etc.
   c. In one example, a flag may be signaled to indicate whether interweaved prediction is used or not. In one example, a flag signaled to indicate whether interweaved prediction is used or not, if the current block is affine inter-coded.
   d. In one example, a flag may be signaled to indicate whether interweaved prediction is used or not, if the current block is affine merge-coded and applies uni-prediction.
   e. In one example, a flag may be signaled to indicate whether interweaved prediction is used or not, if the current block is affine merge-coded.
   f. In one example, interweaved prediction may be always used if the current block is affine merge-coded and applies uni-prediction.
   g. In one example, interweaved prediction may be always used if the current block is affine merge-coded.
   h. In one example, the flag to indicate whether interweaved prediction is used or not may be inherited without being signaled.
      i. In one example, the inheritance may be used if the current block is affine merge-coded.
      ii. In one example, the flag may be inherited from the flag of the neighbouring block where the affine model is inherited from.
      iii. In one example, the flag is inherited from a predefined neighboring block such as the left or above neighbouring block.
      iv. In one example, the flag may be inherited from the first encountered affine-coded neighbouring block.
      v. In one example, the flag may be inferred to be zero if no neighbouring block is affine-coded.
      vi. In one example, the flag may be only inherited when the current block applies uni-prediction.
      vii. In one example, the flag may be only inherited when the current block and the neighbouring block to be inherited from are in the same CTU.
      viii. In one example, the flag may be only inherited when the current block and the neighbouring block to be inherited from are in the same CTU row.
      ix. In one example, the flag may not be inherited from the flag of the neighbouring block when the affine model is derived from a temporal neighboring block.
      x. In one example, the flag may not be inherited from the flag of a neighboring block which is not located in the same LCU or LCU row or video data processing unit (such as 64×64, or 128×128).
      xi. In one example, how to signal and/or derive the flag may depend on the block dimension of the current block and/or coded information.
   i. In one example, interweaved prediction is not applied if the reference picture is the current picture.
      i. In one example, the flag to indicate whether interweaved prediction is used or not is not signaled if the reference picture is the current picture.

### Weighting Values

7. The weighting values w are fixed. For example, wᵢ(x, y)=1 in eq (15) and eq (16).
8. The weighting values may depend on position as well as the dividing pattern, i.e., wᵢ(x,y) may be different for different (x, y). Alternatively, the weighting values may further depend on the sub-block prediction based coding tools (e.g., affine, or ATMVP) and/or other coded information (e.g., skip or non-skip modes, and/or MV information, et al).
9. Weighting values can be transmitted from the encoder to the decoder at sequence level, picture level, slice level, Coding Tree Unit (CTU) (a. k. a. Largest Coding Unit (LCU) level, CU level, or PU level or region level which may contain multiple CUs/PUs/Tus/LCUs. They can be signaled in Sequence Parameter Set (SPS), Picture Parameter Set (PPS), Slice Header (SH), CTU (a. k. a. LCU), CU or PU or the first block of a region.
   a. In one alternative solution, furthermore, for some blocks, it may inherit the weighting values from a spatial and/or temporal neighboring block.

### Partial Interweaved Prediction

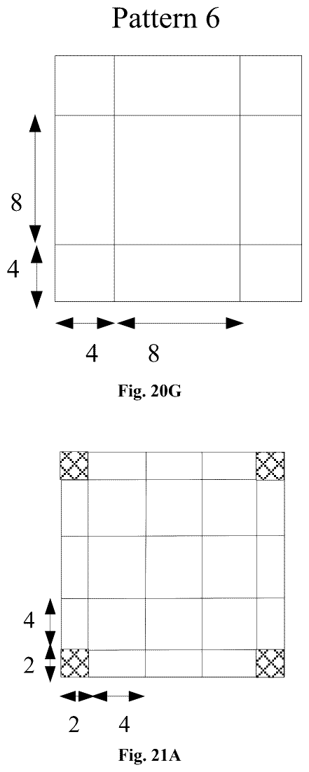

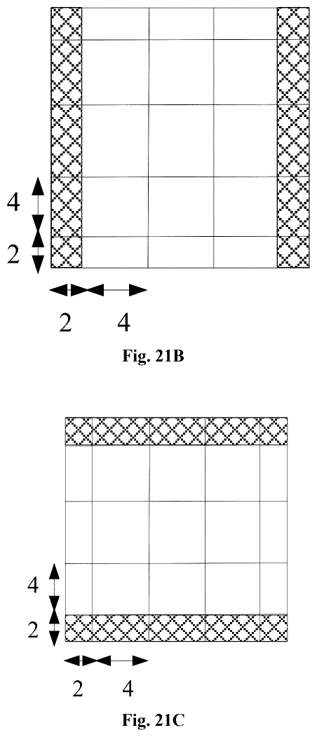

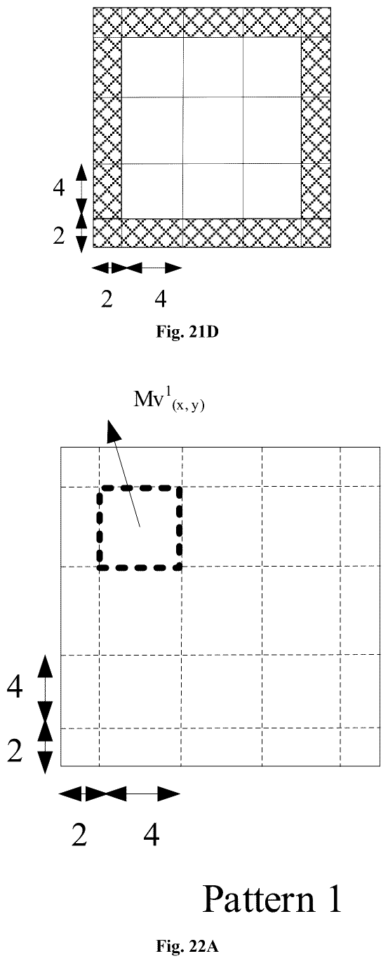

10. In one embodiment, interweaved prediction is applied to a part of the current block. Prediction samples at some positions are calculated as the weighted sum of two or more sub-block based predictions. Prediction samples at other positions are not. For example, these prediction samples are copied from the sub-block based prediction with a certain dividing pattern. FIG. 21A-FIG. 21D illustrate examples of partial interweaved prediction. Interweaved prediction is not applied on shaded areas.
   a. In one example, the current block is predicted by sub-block based prediction P1 and P2 with dividing pattern DO and dividing pattern D1, respectively. The final prediction is calculated as P=w0×P0+w1×P1. At some positions, w0 ≠0 and w1≠0. But at some other positions, w0=1 and w1=0, that is, interweaved prediction is not applied at those positions.
   b. In one example, interweaved prediction is not applied on four corner sub-blocks as shown in FIG. 21A.
   c. In one example, interweaved prediction is not applied on the left-most column of sub-blocks and right-most column of sub-blocks as shown in FIG. 21B.
   d. In one example, interweaved prediction is not applied on the top-most row of sub-blocks and bottom-most row of sub-blocks as shown in FIG. 21C.
   e. In one example, interweaved prediction is not applied on the top-most row of row of sub-blocks, bottom-most row of sub-blocks the left-most column of sub-blocks and right-most column of sub-blocks as shown in FIG. 21D.
   f. In one example, whether to and how to apply partial interweaved prediction may depend on the size/shape of the current block.
      i. For example, interweaved prediction is applied to the whole block if the size of the current block satisfies certain conditions; otherwise, interweaved prediction is applied to a part (or some parts) of the block. The conditions include but not limited to: (suppose the width and height of the current block is W and H respectively and T, T1, T2 are integer values):

$$1. W >= T 1 and H >= T 2 ;$$

$$2. W <= T 1 and H <= T 2 ;$$

$$3. W >= T 1 or H >= T 2 ;$$

$$4. W <= T 1 or H <= T 2 ;$$

$$5. W + H > = T ;$$

$$6. W + H < = T ;$$

$$7. W \times H > = T ;$$

$$8. W \times H < = T .$$

ii. For example, interweaved prediction is not applied on the left-most column of sub-blocks and right-most column of sub-blocks as shown in FIG. 21B if W>=H; Otherwise, interweaved prediction is not applied on the top-most row of sub-blocks and bottom-most row of sub-blocks as shown in FIG. 21C.
iii. For example, interweaved prediction is not applied on the left-most column of sub-blocks and right-most column of sub-blocks as shown in FIG. 21B if W>H; Otherwise, interweaved prediction is not applied on the top-most row of sub-blocks and bottom-most row of sub-blocks as shown in FIG. 21C.
g. It is proposed that whether and how to apply interweaved prediction may be different for different regions in a block.
   i. For example, suppose the current block is predicted by sub-block based prediction P1 and P2 with dividing pattern DO and dividing pattern D1, respectively. The final prediction is calculated as P(x, y)=w0×P0(x, y)+w1×P1(x, y). If the position (x, y) belongs to a sub-block with dimensions S0×H0 with the dividing pattern D0; and belongs to a sub-block S1×H1 with the dividing pattern D1. If one or several following conditions are satisfied, set w0=1 and wᵢ=0. (i.e., interweaved prediction is not applied at this position).
      1. S1<T1;
      2. H1<T2;
      3. S1<T1 and H1<T2;
      4. S1<T1 or H1<T2;
      T1 and T2 are integers. For example, T1=T2=4.

### Encoder Issue

11. In one embodiment, interweaved prediction is not applied in the motion estimation (ME) process.
   a. For example, interweaved prediction is not applied in the ME process for the 6-parameter affine prediction.
   b. For example, interweaved prediction is not applied in the ME process if the size of the current block satisfies certain conditions such as (suppose the width and height of the current block is W and H respectively and T, T1, T2 are integer values):

$$i . W >= T 1 and H >= T 2 ;$$

$$ii . W <= T 1 and H <= T 2 ;$$

$$iii . W >= T 1 or H >= T 2 ;$$

$$iv . W <= T 1 or H <= T 2 ;$$

$$v . W + H > = T ;$$

$$vi . W + H < = T ;$$

$$vii . W \times H > = T ;$$

$$viii . W \times H < = T .$$

c. For example, interweaved prediction is not applied in the ME process if the current block is split from a parent block, and the parent block does not choose affine mode at encoder.
   i. Alternatively, affine mode is not checked at encoder if the current block is split from a parent block, and the parent block does not choose affine mode at encoder.

### MV Derivation

In the following discussion, SatShift(x, n) is defined as

$$SatShift ( x , n ) = \{ \begin{matrix}x + offsset 0 ) ≫ n & if & x \geq 0 \\ - ( ( - x + offset 1 ) ≫ n ) & if & x < 0\end{matrix} .$$

Shift(x, n) is defined as Shift(x, n)=(x+offset0)n.

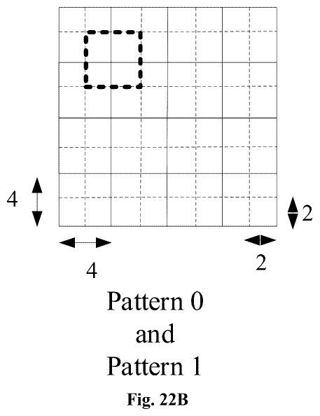

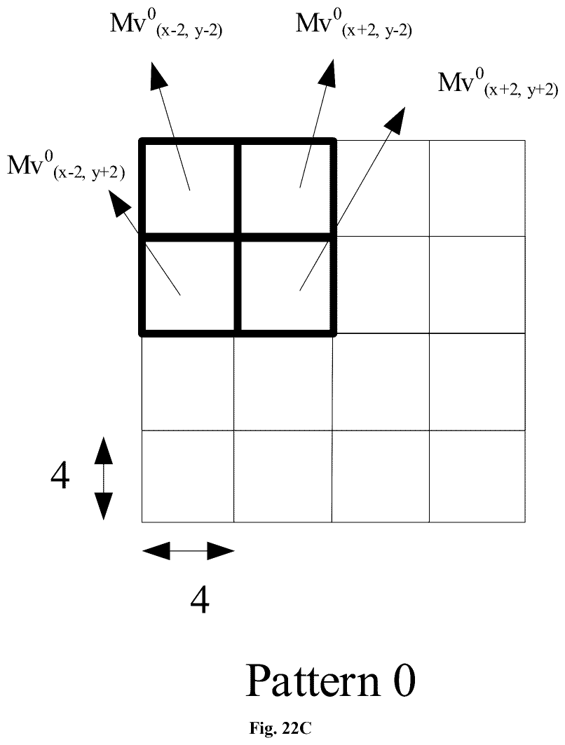

In one example, offset0 and/or offset1 are set to (1n)1 or (1(n−1)). In another example, offset0 and/or offset1 are set to 0.
12. The MV of each sub-block within one dividing pattern may be derived from the affine model (such as with Eq(1)) directly, or it may be derived from MVs of sub-blocks within another dividing pattern.
   a. In one example, the MV of a sub-block B with dividing pattern 0, may be derived from MVs of all or some of the sub-blocks within dividing pattern 1, that overlap with sub-block B.
   b. FIG. 22A-FIG. 22C illustrate examples. In FIG. 22A, MV1(x,y) of a specific sub-block within dividing pattern 1 is to be derived. FIG. 22B shows dividing pattern 0 (solid) and dividing pattern 1 (dashed) in the block, indicating that there are four sub-blocks with in dividing pattern 0 overlapping with the specific sub-block within dividing pattern 1. FIG. 22C shows the four MVs: MV0(x−2,y−2), MV0(x+2,y−2), MV0(x−2,y+2) and MV0(x+2,y+2) of the four sub-blocks with in dividing pattern 0 overlapping with the specific sub-block within dividing pattern 1. Then MV1(x,y) will be derived from MV0(x−2,y−2), MV0(x+2,y−2), MV0(x−2,y+2) and MV0(x+2,y+2).
      c. Suppose MV′ of one sub-block within dividing pattern 1 is derived from MV0, MV1, MV2, . . . MVk of k−1 sub-blocks within dividing pattern 0. MV′ may be derived as:
      i. MV′=MVn, n is any of 0 . . . k.
      ii. MV′=f(MV0, MV1, MV2, . . . , MVk). f is a linear function.
      iii. MV′=f(MV0, MV1, MV2, . . . , MVk). f is a non-linear function.
      iv. MV′=Average(MV0, MV1, MV2, . . . , MVk). Average is an averaging operation.
      v. MV′=Median(MV0, MV1, MV2, . . . , MVk). Median is an operation to get the median value.
      vi. MV′=Max(MV0, MV1, MV2, . . . , MVk). Max is an operation to get the maximum value.
      vii. MV′=Min(MV0, MV1, MV2, . . . , MVk). Min is an operation to get the minimum value.
      viii. MV′=MaxAbs(MV0, MV1, MV2, . . . , MVk). MaxAbs is an operation to get the value with the maximum absolute value.
      ix. MV′=MinAbs(MV0, MV1, MV2, . . . , MVk). MinAbs is an operation to get the value with the minimum absolute value.
      x. Take FIG. 22A-FIG. 22C as an example, MV1(x,y) may be derived as:

$$1. MV 1 ( x , y ) = SatShift ( MV 0 ( x - 2 , y - 2 ) + M V 0 ( x + 2 , y - 2 ) + M V 0 ( x - 2 , y + 2 ) + MV 0 ( x + 2 , y + 2 ) , 2 ) ;$$

$$2. MV 1 ( x , y ) = Shift ( MV 0 ( x - 2 , y - 2 ) + M V 0 ( x + 2 , y - 2 ) + M V 0 ( x - 2 , y + 2 ) + MV 0 ( x + 2 , y + 2 ) , 2 ) ;$$

$$3. MV 1 ( x , y ) = SatShift ( MV 0 ( x - 2 , y - 2 ) + M V 0 ( x + 2 , y - 2 ) , 1 ) ;$$

$$4. MV 1 ( x , y ) = Shift ( MV 0 ( x - 2 , y - 2 ) + M V 0 ( x + 2 , y - 2 ) , 1 ) ;$$

$$5. MV 1 ( x , y ) = SatShift ( M V 0 ( x - 2 , y + 2 ) + M V 0 ( x + 2 , y + 2 ) , 1 ) ;$$

$$6. MV 1 ( x , y ) = Shift ( MV 0 ( x - 2 , y + 2 ) + M V 0 ( x + 2 , y + 2 ) , 1 ) ;$$

$$7. MV 1 ( x , y ) = SatShift ( M V 0 ( x - 2 , y - 2 ) + M V 0 ( x + 2 , y + 2 ) , 1 ) ;$$

$$8. MV 1 ( x , y ) = Shift ( MV 0 ( x - 2 , y - 2 ) + MV 0 ( x + 2 , y + 2 ) , 1 ) ;$$

$$9. MV 1 ( x , y ) = SatShift ( M V 0 ( x - 2 , y - 2 ) + M V 0 ( x - 2 , y + 2 ) , 1 ) ;$$

$$10. MV 1 ( x , y ) = Shift ( MV 0 ( x - 2 , y - 2 ) + M V 0 ( x - 2 , y + 2 ) , 1 ) ;$$

$$11. MV 1 ( x , y ) = SatShift ( M V 0 ( x + 2 , y - 2 ) + M V 0 ( x + 2 , y + 2 ) , 1 ) ;$$

$$12. MV 1 ( x , y ) = Shift ( MV 0 ( x + 2 , y - 2 ) + M V 0 ( x + 2 , y + 2 ) , 1 ) ;$$

$$13. MV 1 ( x , y ) = SatShift ( M V 0 ( x + 2 , y - 2 ) + M V 0 ( x - 2 , y + 2 ) , 1 ) ;$$

$$14. MV 1 ( x , y ) = Shift ( MV 0 ( x + 2 , y - 2 ) + M V 0 ( x - 2 , y + 2 ) , 1 ) ;$$

$$15. MV 1 ( x , y ) = MV 0 ( x - 2 , y - 2 ) ;$$

$$16. MV 1 ( x , y ) = MV 0 ( x + 2 , y - 2 ) ;$$

$$17. MV 1 ( x , y ) = MV 0 ( x - 2 , y + 2 ) ;$$

$$18. MV 1 ( x , y ) = MV 0 ( x + 2 , y + 2 ) .$$

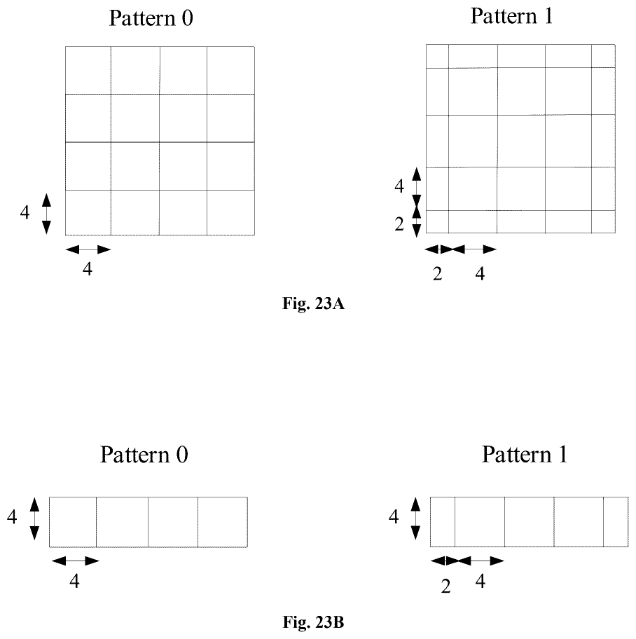

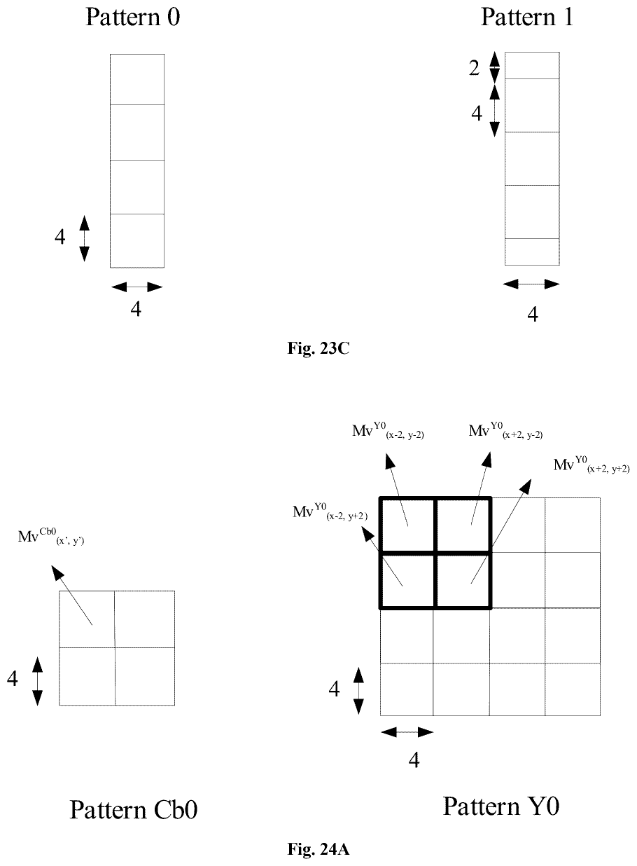

13. How to select the dividing pattern may depend on the width and height of the current block. FIG. 23A-FIG. 23C illustrate examples of choosing dividing patterns depending on block dimensions.
   a. For example, if width >T1 and height >T2 (e.g. T1=T2=4), two dividing patterns are selected. FIG. 23A show an example of two dividing patterns.
   b. For example, if height <=T2 (e.g. T2=4), another two dividing patterns are selected. FIG. 23B show an example of two dividing patterns.
   c. For example, if width <=T1 (e.g. T1=4), yet another two dividing patterns are selected. FIG. 23C show an example of two dividing patterns.
14. The MV of each sub-block within one dividing pattern of one color component C1 may be derived from MVs of sub-blocks within another dividing pattern of another color component C0.
   a. For example, C1 refers to color component coded/decoded after another color component, such as Cb or Cr or U or V or R or B.
   b. For example, CO refers to color component coded/decoded before another color component, such as Y or G.
   c. In one example, how to derive MV of a sub-block within one dividing pattern of one color component from MVs of MVs of sub-blocks within another dividing pattern of another color component may depend on the color format, such as 4:2:0, or 4:2:2, or 4:4:4.
   d. In one example, the MV of a sub-block B in color component C1 with dividing pattern C1Pt (t=0 or 1), may be derived from MVs of all or some of the sub-blocks in color component CO within dividing pattern C0Pr (r−0 or 1), that overlap with sub-block B, after down-scaling or up-scaling the coordinates according to the color format.
      i. In one example, C0Pr is always equal to C0P0.
   e. FIG. 24A and FIG. 24B illustrate an example. FIG. 24A and FIG. 24B illustrate examples of deriving MVs of sub-blocks in one component within a dividing pattern from MVs of sub-block in another component within another dividing pattern. The color format is 4:2:0. MVs of sub-blocks in Cb component are derived from MVs of sub-blocks in Y component.
      i. In FIG. 24A left, MVCb0(x′,y′) of a specific Cb sub-block B within dividing pattern 0 is to be derived. FIG. 24A right shows four Y sub-blocks with in dividing pattern 0, which are overlapped with Cb sub-block B when down-scaled by 2:1. Suppose x=2*x′ and y=²*y′, four MVs: MV0(x−2,y−2), MV0(x+2,y−2), MV0(x−2,y+2) and MV0(x+2,y+2) of the four Y sub-blocks with in dividing pattern 0 are used to derive the MVCb0(x′,y′).
      ii. In FIG. 24B left, MVCb0(x′,y′) of a specific Cb sub-block B within dividing pattern 1 is to be derived. FIG. 24B right shows four Y sub-blocks with in dividing pattern 0, which are overlapped with Cb sub-block B when down-scaled by 2:1. Suppose x=2*x′ and y=²*y′, four MVs: MV0(x−2,y−2), MV0(x+2,y−2), MV0(x−2,y+2) and MV0(x+2,y+2) of the four Y sub-blocks with in dividing pattern 0 are used to derive the MVCb0(x′,y′).
   f. Suppose MV′ of one sub-block of color component C1 is derived from MV0, MV1, MV2, . . . MVk of k−1 sub-blocks of color component CO. MV′ may be derived as:
      i. MV′=MVn, n is any of 0 . . . k.
      ii. MV′=f(MV0, MV1, MV2, . . . , MVk). f is a linear function.
      iii. MV′=f(MV0, MV1, MV2, . . . , MVk). f is a non-linear function.
      iv. MV′=Average(MV0, MV1, MV2, . . . , MVk). Average is an averaging operation.
      v. MV′=Median(MV0, MV1, MV2, . . . , MVk). Median is an operation to get the median value.
      vi. MV′=Max(MV0, MV1, MV2, . . . , MVk). Max is an operation to get the maximum value.
      vii. MV′=Min(MV0, MV1, MV2, . . . , MVk). Min is an operation to get the minimum value.
      viii. MV′=MaxAbs(MV0, MV1, MV2, . . . , MVk). MaxAbs is an operation to get the value with the maximum absolute value.
      ix. MV′=MinAbs(MV0, MV1, MV2, . . . , MVk). MinAbs is an operation to get the value with the minimum absolute value.
      x. Take FIG. 24A and FIG. 24B as an example, MVCbt(x′,y′) t=0 or 1, may be derived as:

$$1. MVCbt ( {x}^{′} , {y}^{′} ) = SatShift ( MV 0 ( x - 2 , y - 2 ) + M V 0 ( x + 2 , y - 2 ) + M V 0 ( x - 2 , y + 2 ) + MV 0 ( x + 2 , y + 2 ) , 2 ) ;$$

$$2. MVCbt ( {x}^{′} , {y}^{′} ) = Shift ( MV 0 ( x - 2 , y - 2 ) + M V 0 ( x + 2 , y - 2 ) + M V 0 ( x - 2 , y + 2 ) + MV 0 ( x + 2 , y + 2 ) , 2 ) ;$$

$$3. MVCbt ( {x}^{′} , {y}^{′} ) = SatShift ( M V 0 ( x - 2 , y - 2 ) + M V 0 ( x + 2 , y - 2 ) , 1 ;$$

$$4. MVCbt ( {x}^{′} , {y}^{′} ) = Shift ( MV 0 ( x - 2 , y - 2 ) + M V 0 ( x + 2 , y - 2 ) , 1 ) ;$$

$$5 . MVCbt ( {x}^{′} , {y}^{′} ) = SatShift ( MV 0 ( x - 2 , y + 2 ) + M V 0 ( x + 2 , y + 2 ) , 1 ) ;$$

$$6 . MVCbt ( {x}^{′} , {y}^{′} ) = Shift ( MV 0 ( x - 2 , y + 2 ) + M V 0 ( x + 2 , y + 2 ) , 1 ) ;$$

$$7 . MVCbt ( {x}^{′} , {y}^{′} ) = SatShfit ( MV 0 ( x - 2 , y - 2 ) + M V 0 ( x + 2 , y + 2 ) , 1 ) ;$$

$$8 . MVCbt ( {x}^{′} , {y}^{′} ) = Shift ( MV 0 ( x - 2 , y - 2 ) + M V 0 ( x + 2 , y + 2 ) , 1 ) ;$$

$$9 . MVCbt ( {x}^{′} , {y}^{′} ) = SatShift ( MV 0 ( x - 2 , y - 2 ) + M V 0 ( x - 2 , y + 2 ) , 1 ) ;$$

$$10 . MVCbt ( {x}^{′} , {y}^{′} ) = Shift ( MV 0 ( x - 2 , y - 2 ) + M V 0 ( x - 2 , y + 2 ) , 1 ) ;$$

$$11 . MVCbt ( {x}^{′} , {y}^{′} ) = SatShift ( MV 0 ( x + 2 , y - 2 ) + M V 0 ( x + 2 , y + 2 ) , 1 ) ;$$

$$12 . MVCbt ( {x}^{′} , {y}^{′} ) = Shift ( MV 0 ( x + 2 , y - 2 ) + M V 0 ( x + 2 , y + 2 ) , 1 ) ;$$

$$13 . MVCbt ( {x}^{′} , {y}^{′} ) = SatShift ( MV 0 ( x + 2 , y - 2 ) + M V 0 ( x - 2 , y + 2 ) , 1 ) ;$$

$$14 . MV 1 ( x , y ) = Shift ( MV 0 ( x + 2 , y - 2 ) + M V 0 ( x - 2 , y + 2 ) , 1 ) ;$$

$$15 . MVCbt ( {x}^{′} , {y}^{′} ) = MV 0 ( x - 2 , y - 2 ) ;$$

$$16 . MVCbt ( {x}^{′} , {y}^{′} ) = MV 0 ( x + 2 , y - 2 ) ;$$

$$17 . MVCbt ( {x}^{′} , {y}^{′} ) = MV 0 ( x - 2 , y + 2 ) ;$$

$$18 . MVCbt ( {x}^{′} , {y}^{′} ) = MV 0 ( x + 2 , y + 2 ) .$$

### Interweaved Prediction for Bi-Prediction

15. When interweaved prediction is applied on bi-prediction, the following methods may be applied to save the internal bitdepth increased due to different weights:
   a. For list X (X=0 or 1), PX(x, y)=Shift(W0(x,y)*PX0(x,y)+W1(x,y)*PX1(x,y), SW), where PX(x, y) is the prediction for list X, PX0(x,y) and PX1(x,y) are the prediction for list X with dividing pattern 0 and dividing pattern 1, respectively. W0 and W1 are integers representing the interweaved prediction weighting values and SW represents the precision of the weighting values.
   b. The final prediction value is derived as P(x,y)=Shift(Wb0(x,y)*P0(x,y)+Wb1(x,y)*P1(x,y), SWB), where Wb0 and Wb1 are integers used in weighted bi-prediction and SWB is the precision. When there is no weighted bi-prediction, Wb0=Wb1=SWB=1.
   c. In some embodiments, PX0(x,y) and PX1(x,y) may be kept the precision of interpolation filtering. For example, they may be unsigned integers with 16 bits. The final prediction value is derived as P(x,y)=Shift(Wb0(x,y)*P0(x,y)+Wb1(x,y)*P1(x,y), SWB+PB), where PB is the additional precision from interpolation filtering, e.g., PB=6. In this case, W0(x,y)*PX0(x,y) or W1(x,y)*PX1(x,y) may exceed 16 bits. It is proposed that PX0(x,y) and PX1(x,y) are right-shift to a lower precision first, to avoid exceeding 16 bits.
      i. For example, For list X (X=0 or 1), PX(x, y)=Shift(W0(x,y)*PLX0(x,y)+W1(x,y)*PLX1(x,y), SW), where PLX0(x,y)=Shift(PX0(x,y), M), PLX1(x,y)=Shift(PX1(x,y), M). And the final prediction is derived as P(x,y)=Shift(Wb0(x,y)*P0(x,y)+Wb1(x,y)*P1(x,y), SWB+PB-M). For example, M is set to be 2 or 3.
   d. The above mentioned methods may be also applicable to other bi-prediction methods with different weighting factors for two reference prediction blocks, such as Generalized Bi-Prediction (GBi, wherein weights could be e.g., ⅜, ⅝), weighted prediction (wherein weights could be a very large value).
   e. The above mentioned methods may be also applicable to other multiple hypothesis uni-prediction or bi-prediction methods with different weighting factors for different reference prediction blocks.

### Block Size Dependents

16. Whether and/or how to apply interweaved prediction may depend on block width W and height H.
   a. In one example, whether and/or how to apply interweaved prediction may depend on the size of VPDU (Video Processing Data Unit which typically represent the maximumly allowed block size for processing in hardware design).
   b. In one example, when interweaved prediction is disabled for a certain block dimension (or a block with certain coded information), the original prediction method may be utilized.
      i. Alternatively, affine mode may be directly disabled for such kind of blocks.
   c. In one example, interweaved prediction cannot be used when W>T1 and H>T2. For example, T1=T2=64;
   d. In one example, interweaved prediction cannot be used when W>T1 or H>T2. For example, T1 =T2=64;
   e. In one example, interweaved prediction cannot be used when W*H>T. For example, T=64*64;
   f. In one example, interweaved prediction cannot be used when W<T1 and H<T2. For example, T1=T2=16;
   g. In one example, interweaved prediction cannot be used when W<T1 or H>T2. For example, T1 =T2=16;
   h. In one example, interweaved prediction cannot be used when W*H<T. For example, T=16 * 16.
   i. In one example, for a sub-block which is not located at block boundary (e.g., coding unit), interweaved affine may be disabled for this sub-block. Alternatively, furthermore, the prediction results with original affine prediction method may be directly used as the final prediction for this sub-block.
   j. In one example, interweaved prediction is used in a different way when W>T1 and H>T2. For example, T1=T2=64;
   k. In one example, interweaved prediction is used in a different way when W>T1 or H>T2. For example, T1=T2=64;
   l. In one example, interweaved prediction is used in a different way when W*H>T. For example, T=64*64;
   m. In one example, interweaved prediction is used in a different way when W<T1 and H<T2. For example, T1=T2=16;
   n. In one example, interweaved prediction is used in a different way when W<T1 or H>T2. For example, T1=T2=16;
   o. In one example, interweaved prediction is used in a different way when W*H<T. For example, T=16*16.
   p. In one example, when H >X (e.g. H is equal to 128, X=64), the interweaved prediction is not applied on samples belonging to a sub-blocks crossing the upper W*(H/2) partition and the lower W*(H/2) partition of the current block.
   q. In one example, when W >X (e.g. W is equal to 128, X=64), the interweaved prediction is not applied on samples belonging to a sub-blocks crossing the left (W/2)*H partition and the right (W/2)*H partition of the current block.
   r. In one example, when W >X and H >Y (e.g. W=H=128, X=Y=64),
      i. the interweaved prediction is not applied on samples belonging to a sub-blocks crossing the left (W/2)*H partition and the right (W/2)*H partition of the current block.
      ii. the interweaved prediction is not applied on samples belonging to a sub-blocks crossing the upper W*(H/2) partition and the lower W*(H/2) partition of the current block.
   s. In one example, interweaved prediction is only enabled for blocks with specific sets of width and/or height.
   t. In one example, interweaved prediction is only disabled for blocks with specific sets of width and/or height.
   u. In one example, interweaved prediction is only used for specific types of picture/slice/tile group/tile/or other kinds of video data units.
      i. For example, interweaved prediction is only used for P picture or B picture.
      ii. For example, a flag is signaled to indicate whether interweaved prediction can be used or not in the header of picture/slice/tile group/tile.
         1. For example, this flag is signaled only if affine prediction is allowed.
17. It is proposed that a message is signaled to indicate whether to apply the dependency between whether/how to apply interweaved prediction and the width and height. The message may be signaled in SPS/VPS/PPS/Slice header/picture header/tile/tile group header/CTUs/CTU rows/multiple CTUs/or other kinds of video processing units.
18. In one example, when interweaved prediction is used, bi-prediction is disallowed.
   a. For example, when interweaved prediction is used, the index to indicate whether bi-prediction is used is not signaled.
   b. Alternatively, indications of whether bi-prediction is disallowed may be signaled in SPS/VPS/PPS/Slice header/picture header/tile/tile group header/CTUs/CTU rows/multiple CTUs.
19. It is proposed to further refine sub-blocks' motion information based on motion information derived from two or multiple patterns.
   a. In one example, the refined motion information may be utilized for predicting following blocks to be coded.
   b. In one example, the refined motion information may be utilized in the filtering process, such as Deblock, SAO, ALF.
   c. Whether to store the refined information may be based on the position of sub-block relative to the whole block/CTU/CTU row/tile/slice/tile groups/picture.
   d. Whether to store the refined information may be based on the coded mode of current block and/or neighboring blocks.
   e. Whether to store the refined information may be based on the dimension of current block.
   f. Whether to store the refined information may be based on picture/slice types/reference picture lists etc. al.
20. It is proposed that whether to and/or how to apply deblocking process or other kinds of filtering process (such as SAO, Adaptive loop filter)may depend on whether interweaved prediction is applied or not.
   a. In one example, deblocking is not conducted on an edge between two sub-blocks in one division pattern for a block if the edge is inside a sub-block in another division pattern for a block.
   b. In one example, deblocking is made weaker on an edge between two sub-blocks in one division pattern for a block if the edge is inside a sub-block in another division pattern for a block.
      i. In one example, bS[xDi][yDj] described in the VVC deblocking process is decreased for such a edge.
      ii. In one example, β described in the VVC deblocking process is decreased for such a edge.
      iii. In one example, Δ described in the VVC deblocking process is decreased for such a edge.
      iv. In one example, tC described in the VVC deblocking process is decreased for such a edge.
   c. In one example, deblocking is made stronger on an edge between two sub-blocks in one division pattern for a block if the edge is inside a sub-block in another division pattern for a block.
      i. In one example, bS[xDi][yDj] described in the VVC deblocking process is increased for such a edge.
      ii. In one example, β described in the VVC deblocking process is increased for such a edge.
      iii. In one example, Δ described in the VVC deblocking process is increased for such a edge.
      iv. In one example, tC described in the VVC deblocking process is increased for such a edge.
21. It is proposed that whether to and/or how to apply local illumination compensation or weighted prediction to a block/sub-block may depend on whether interweaved prediction is applied or not.
   a. In one example, when one block is coded with interweaved prediction mode, it is disallowed to apply local illumination compensation or weighted prediction.
   b. Alternatively, furthermore, there is no need to signal indications of enabling local illumination compensation if interweaved prediction is applied to a block/sub-block.
22. It is proposed that when weighted prediction is applied to one block or sub-block, bi-directional optical flow (BIO) may be skipped.
   a. In one example, BIO may be applied to blocks with weighted prediction.
   b. In one example, BIO may be applied to blocks with weighted prediction, however, certain conditions shall be satisfied.
      i. In one example, it is required that at least one parameter shall be within one range, or equal to certain values.
      ii. In one example, certain reference pictures restrictions may be applied.

### 3. Problems

The existing subblock based prediction technologies have the following problems:
1) They face a dilemma. The motion information of each sub-block may be more accurate if the size of sub-blocks is smaller. However, smaller sub-blocks impose a higher bandwidth requirement in MC.
2) Motion information derived for smaller sub-block might be dangerous especially when there are some noises in a block. Fixing the sub-block size within one block may be sub-optimal.

### 4. Detailed Solutions

In this disclosure, it is proposed to further improve subblock based motion compensation. In particular, interweaved prediction is improved to be compatible with pixel based affine motion compensation. Besides, regression affine is also improved.

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.

### On Interweaved Affine

1. The usage of interweaved prediction on affine mode may be dependent on another coding method.
   a) In one example, if pixel based affine motion compensation is applied to a coding block, then interweaved prediction may not be applied.
   b) In one example, interweaved affine prediction and pixel based affine can not be simultaneously used for a coding block.
      i. In one example, alternatively, interweaved affine prediction and pixel based affine may be simultaneously used for a coding block.
         1) In one example, for a coding block, partial pixels may be predicted by interweaved affine, while (some) other pixels may be predicted by pixel based affine.
         2) In one example, the predictions of interweaved affine and pixel based affine may be blended to generate a new prediction.
2. The usage of interweaved affine prediction and/or pixel based affine motion compensation may be dependent on block dimension.
   a) In one example, if the block dimension satisfies certain conditions, interweaved affine prediction is used.
      i. In one example, specifically, if both (or either) height and width are larger or smaller than a threshold, or the ratio of height and width is larger or smaller than a threshold, interweaved affine prediction may be used.
   b) In one example, alternatively, if the block dimension doesn't satisfy the same condition, pixel based affine is used instead.
   c) In one example, the dimension condition may be imposed together with other conditions.
      i. In one example, OBMC flag may be used together with dimension condition.
         1) In one example, specifically, if OBMC is used for a block, and block dimension satisfies certain condition, then pixel affine is used to generation prediction.
   d) In one example, whether interweaved affine is applied or not may be dependent on the subblock size.
      i. In one example, if subblock size is smaller than a threshold, e.g., 4×4, then interweaved affine is not applied.
3. In one example, when interweaved affine is used, or pixel based affine is not used, the size of the largest subblock to perform affine prediction is set to a constant.
4. In one example, PROF (affine prediction refinement with optical flow) may be performed for interweaved affine.
   a) In one example, both predictions generated by the two dividing patterns are refined by PROF.
      i. In one example, only the prediction generated by a particular dividing pattern is refined by PROF.
      ii. In one example, PROF is not applied if interweaved affine is used for a block.
   b) In one example, for certain dividing pattern, only partial prediction samples are refined by PROF.
      i. In one example, if either width or height of a subblock is smaller than a threshold, e.g., 4, then PROF is not applied to this subblock.
5. It is proposed that whether to and/or how to apply subblock-boundary deblocking process or other kinds of subblock-boundary based filtering process (such as SAO, Adaptive loop filter, OBMC) may depend on whether affine mode/pixel based affine/interweaved prediction is applied or not.
   a) In one example, if affine mode/pixel based affine/interweaved prediction is applied, some or all kinds of subblock-boundary based deblocking/filtering process is not applied.
      i. In one example, specifically, if affine mode/pixel based affine/interweaved prediction is applied, subblock-boundary oriented deblocking and/or OBMC is not applied.

### On OBMC

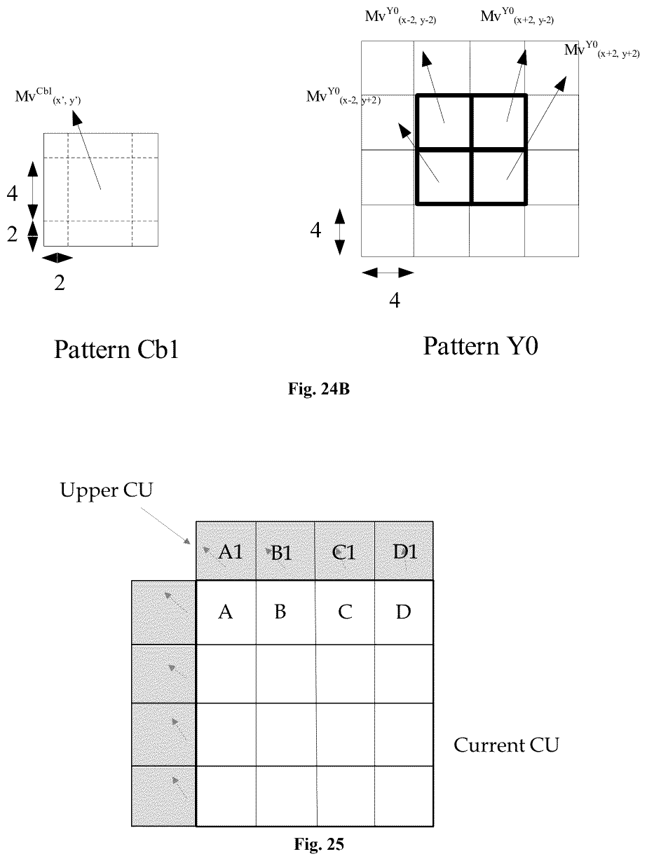

FIG. 25 illustrates examples of CU level OBMC.
6. It is proposed that whether to and/or how to apply CU level OBMC may dependent on the coding mode.
   a) In one example, if subblock level inter modes (such as affine, SbTMVP, multi-pass DMVR) is used for the current block, then each boundary subblock will conduct CU level OBMC filtering independently.
      i. In one example, specifically, the boundary subblocks are looped one by one. Suppose A is an arbitrary boundary subblock being traversed, and AI is the corresponding neighboring subblock which is used for OBMC filtering. Then A will be filtered if A and AI have different motion. After A finishes filtering, subsequent subblocks will conduct OBMC in a similar way.
   b) In one example, alternatively, if non-subblock level inter mode is used for the current block, then multiple boundary subblocks may conduct OBMC filtering together.
      i. In one example, suppose A is an arbitrary boundary subblock being traversed, and AI is the corresponding neighboring subblock. If AI and subsequent N (N>=0) successive sublocks, e.g., 2 subblocks B1 and Cl in FIG. 25, have identical motion M_nei, and M_nei is different from A's motion in the meanwhile, then (N+1) subblocks (including A) will be filtered together. Otherwise, if M_nei is equal to A's motion, then (N+1) successive subblocks (including A) will skip CU level OBMC filtering.

### On Regression Affine

7. To generate a regression affine candidate, it is proposed to simultaneously use the motion fields of N (N>1) previously coded CUs as the input of regression process.
   a) In one example, N CUs may be collected from adjacent, non-adjacent position, or a history CU/parameter table.
   b) In one example, N CUs are all inter coded.
      i. In one example, N CUs are all coded with affine mode.
      ii. In one example, alternatively, at least K (K>=0) of N are affine coded.
   c) In one example, all the N CUs may need to share the same prediction direction (i.e., bi- or uni-predicted, and/or reference list used), and/or the same reference index/frame.
      i. In one example, alternatively, they may have different prediction direction or reference frame.
   d) In one example, a regression affine candidate may be generated only when the subblock number of N CUs is larger than a constant threshold.
   e) In one example, the motion fields of neighboring or non-adjacent positions may also used as additional input.
      i. In one example, M-row/column neighboring subblocks and/or F-row/column non-adjacent subblocks may be used as input, where M, F >=0.
         1) In one example, the locations of the non-adjacent positions being used may be dependent on the block dimension.
   f) In one example, the proposed regression candidates may be used when the number of existing regression candidates does not reach the maximum allowed number.
   g) In one example, the proposed regression candidates may be reordered based on certain metric, e.g., ARMC or template matching.
   h) In one example, the number of the proposed regression candidates may not exceed a constant or an adaptively determined value.

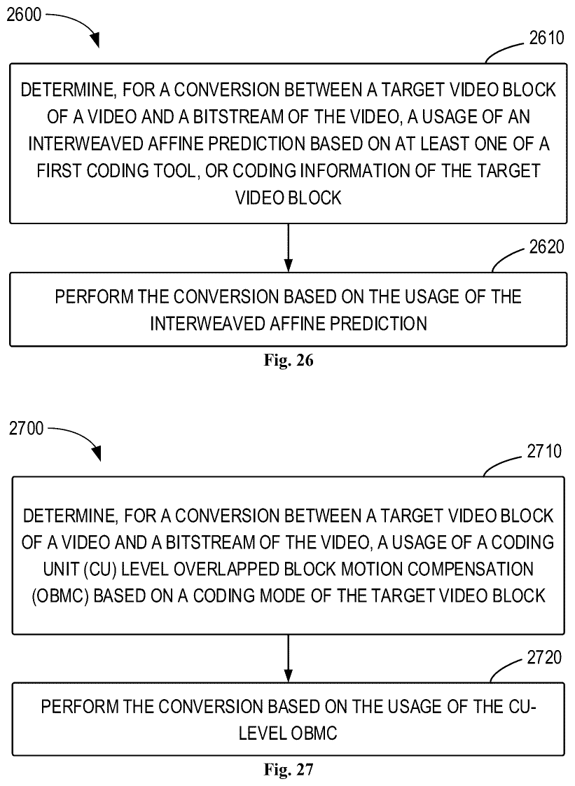

FIG. 26 illustrates a flowchart of a method 2600 for video processing in accordance with embodiments of the present disclosure. The method 2600 is implemented for a conversion between a video block or a video unit of a video and a bitstream of the video.

At block 2610, for a conversion between a target video block of a video and a bitstream of the video, a usage of an interweaved affine prediction is determined based on at least one of a first coding tool, or coding information of the target video block. As used herein, the term “target video unit” refers to a video block or a video unit to be processed, which may also be referred to as a “current video block”.

As used herein, the term “interweaved prediction” refers to a prediction generated with the video block being divided into subblocks using at least two dividing patterns, which is described in section 2.8. The term “interweaved affine prediction” may refer to an interweaved prediction in an affine mode.

At block 2620, the conversion is performed based on the usage of the interweaved affine prediction.

In some embodiments, the conversion includes encoding the target video block into the bitstream.

Alternatively, or in addition, in some embodiments, the conversion includes decoding the target video block from the bitstream.

The method 2600 enables determining whether to apply the interweaved affine prediction based on a further coding tool or coding information of the target video block such as the dimension information. In this way, the coding efficiency can be improved.

In some embodiments, the first coding tool comprises a pixel based affine motion compensation.

In some embodiments, the coding information of the target video block comprises dimension information of the target video block. Determining the usage of the interweaved affine prediction comprises: determining whether the dimension information satisfies at least one condition. The at least one condition comprises at least one of: a first condition that at least one of a height or a width of the target video block is larger than or smaller than a dimension threshold, a second condition that a ratio of the height and the width of the target video block is larger than or smaller than a ratio threshold, or a third condition that a subblock size of the target video block is larger than or equal to a threshold size. If the dimension information of the target video block satisfies the at least one condition, the interweaved affine prediction is enabled. As used herein, an coding tool or coding mode is enabled means that the coding tool or coding mode is applied to the video block. Likewise, an coding tool or coding mode is disabled means that the coding tool or coding mode is not applied to the video block.

In some embodiments, determining the usage of the interweaved affine prediction further comprises: in accordance with a determination that the dimension information of the target video block fails to satisfy the at least one condition, disabling the interweaved affine prediction.

In some embodiments, the method 2600 further comprises: determining a usage of the first coding tool based on the dimension information.

In some embodiments, determining the usage of the first coding tool comprises: in accordance with a determination that the dimension information of the target video block fails to satisfy at least one condition, enabling the first coding tool.

In some embodiments, the usage of at least one of the interweaved affine prediction or the first coding tool is determined further based on a flag of an overlapped block motion compensation (OBMC).

In some embodiments, if the flag of the OBMC indicates that the OBMC is enabled for the target video block and the dimension information satisfies the at least one condition, the first coding tool is enabled.

In some embodiments, the usage the interweaved affine prediction is based on information associated with the first coding tool.

In some embodiments, if the first coding tool is enabled for the target video block, the interweaved affine prediction is disabled.

In some embodiments, the interweaved affine prediction and the first coding tool are not simultaneously used for the target video block, or wherein the interweaved affine prediction and the first coding tool are simultaneously used for the target video block.

In some embodiments, partial pixels of the target video block are predicted by the interweaved affine prediction, and further pixels of the target video block are predicted by the first coding tool.

In some embodiments, a first prediction from the interweaved affine prediction and a second prediction from the first coding tool are blended to generate a third prediction.

In some embodiments, if the interweaved affine prediction is enabled or the first coding tool is disabled, a size of a largest subblock of the target video block is a constant.

In some embodiments, the interweaved affine prediction is enabled for the target video block, and the method further comprises performing a prediction refinement with optical flow (PROF) for the interweaved affine prediction.

In some embodiments, performing the PROF comprises: obtaining a first prediction and a second prediction of the target video block by applying the interweaved affine prediction, the first and second predictions corresponding to a first dividing pattern and a second dividing pattern; and obtaining a first refined prediction and a second refined prediction by performing the PROF on the first and second predictions.

In some embodiments, performing the PROF comprises: obtaining a first prediction and a second prediction of the target video block by applying the interweaved affine prediction, the first and second predictions corresponding to a first dividing pattern and a second dividing pattern; and obtaining a first refined prediction by performing the PROF on the first prediction, without refining the second prediction.

In some embodiments, for the first dividing pattern, partial prediction samples of the first prediction are refined by the PROF.

In some embodiments, if a width or a height of a subblock of the target video block is less than a threshold, the PROF is disabled for prediction samples of the subblock.

In some embodiments, the interweaved affine prediction is enabled for the target video block, and a prediction refinement with optical flow (PROF) is disabled for the interweaved affine prediction.

In some embodiments, the method 2600 further comprises: determining whether to and/or how to apply at least one subblock-boundary based process to the target video block based on whether at least one of: an affine mode, a pixel-based affine, or an interweaved prediction is enabled.

In some embodiments, the at least one subblock-boundary based process comprises at least one of: a subblock-boundary deblocking process, a subblock-boundary based filtering process, a sample adaptive offset (SAO), an adaptive loop filter, or an overlapped block motion compensation (OBMC).

In some embodiments, if at least one of the affine mode, the pixel-based affine, or the interweaved prediction is enabled, at least partial of the at least one subblock-boundary based process is disabled.

In some embodiments, if at least one of the affine mode, the pixel-based affine, or the interweaved prediction is enabled, at least one of: a subblock-boundary based deblocking, or an overlapped block motion compensation (OBMC) is disabled.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a usage of an interweaved affine prediction based on at least one of a first coding tool, or coding information of a target video block of the video; and generating the bitstream based on the usage of the interweaved affine prediction.

According to still further embodiments of the present disclosure, a method for storing bitstream of a video is provided. The method comprises: determining a usage of an interweaved affine prediction based on at least one of a first coding tool, or coding information of a target video block of the video; generating the bitstream based on the usage of the interweaved affine prediction; and storing the bitstream in a non-transitory computer-readable recording medium.

FIG. 27 illustrates a flowchart of a method 2700 for video processing in accordance with embodiments of the present disclosure. The method 2700 is implemented for a conversion between a video unit or a video block of a video and a bitstream of the video.

At block 2710, for a conversion between a target video block of a video and a bitstream of the video, a usage of a coding unit (CU) level overlapped block motion compensation (OBMC) is determined based on a coding mode of the target video block.

At block 2720, the conversion is performed based on the usage of the CU-level OBMC. In some embodiments, the conversion includes encoding the target video block into the bitstream. Alternatively, or in addition, in some embodiments, the conversion includes decoding the target video block from the bitstream.

The method 2700 enables determining whether to apply the CU level OBMC based on the coding mode of the video block. In this way, the coding efficiency can be improved.

In some embodiments, the usage of the CU-level OBMC comprises at least one of: whether to apply the CU-level OBMC, or how to apply the CU-level OBMC.

In some embodiments, if a subblock level inter coding mode is enabled for the target video block, each boundary subblock of the target video block conducts the CU level OBMC filtering independently.

In some embodiments, the subblock level inter coding mode comprises at least one of: an affine mode, a subblock-based temporal motion vector prediction (SbTMVP), or a multi-pass decoder side motion vector refinement (DMVR).

In some embodiments, applying the CU level OBMC filtering comprises: traversing a plurality of boundary subblocks of the target video block. During the traversing for a first boundary subblock of the plurality of boundary subblocks of the target video block, if a motion of the first boundary subblock is different from a motion of a corresponding neighboring subblock for OBMC, the OBMC filtering is applied to the first boundary subblock. After the first boundary subblock is traversed, a subsequent boundary subblock may be traversed in a similar way.

In some embodiments, if a non-subblock level inter coding mode is enabled for the target video block, a plurality of boundary subblocks of the target video block conducts the CU level OBMC filtering together.

In some embodiments, applying the CU level OBMC filtering comprises: traversing the plurality of boundary subblocks. During the traversing of a first boundary subblock of the plurality of boundary subblocks, if a motion of the first boundary subblock is different from a set of motions of a set of neighboring subblocks, a group of boundary subblocks of the plurality of subblocks are filtered together.

The set of motions is identical, the set of subblocks comprises a corresponding neighboring subblock of the first boundary subblock and a first number of successive subblocks of the neighbouring subblock, and the group of boundary subblocks comprising the first boundary subblock and the first number of successive boundary subblocks. After the first boundary subblock is traversed, a subsequent boundary subblock may be traversed in a similar way.

In some embodiments, if the motion of the first boundary subblock is same with the set of motions, the CU level OBMC filtering is skip for the first boundary subblock.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a usage of a coding unit (CU) level overlapped block motion compensation (OBMC) based on a coding mode of a target video block of the video; and generating the bitstream based on the usage of the CU-level OBMC.

According to still further embodiments of the present disclosure, a method for storing bitstream of a video is provided. The method comprises: determining a usage of a coding unit (CU) level overlapped block motion compensation (OBMC) based on a coding mode of a target video block of the video; generating the bitstream based on the usage of the CU-level OBMC; and storing the bitstream in a non-transitory computer-readable recording medium.

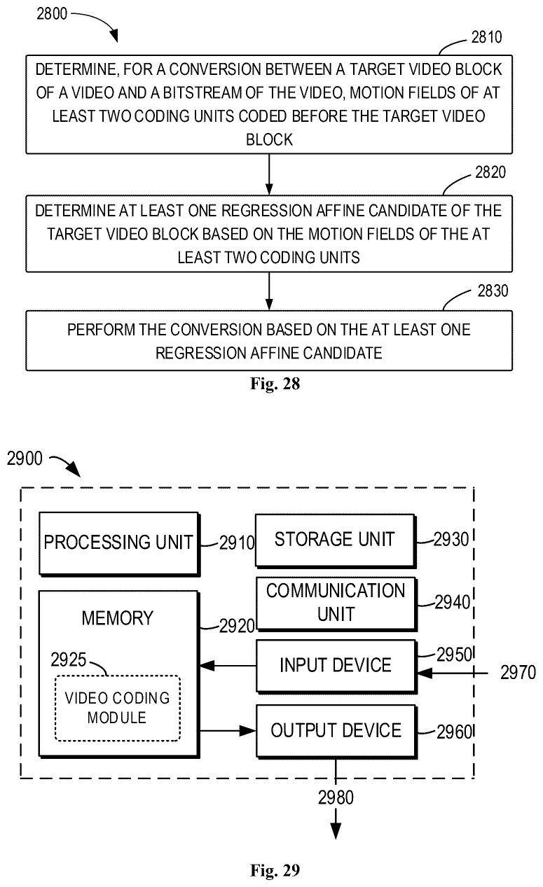

FIG. 28 illustrates a flowchart of a method 2800 for video processing in accordance with embodiments of the present disclosure. The method 2800 is implemented during a conversion between a video unit or a video block of a video and a bitstream of the video.

At block 2810, for a conversion between a target video block of a video and a bitstream of the video, motion fields of at least two coding units coded before the target video block is determined.

At block 2820, at least one regression affine candidate of the target video block is determined based on the motion fields of the at least two coding units.

At block 2830, the conversion is performed based on the at least one regression affine candidate.

In some embodiments, the conversion includes encoding the target video block into the bitstream.

Alternatively, or in addition, in some embodiments, the conversion includes decoding the target video block from the bitstream.

The method 2800 enables generating a regression affine candidate based on motion fields of at least two previously coded coding units. In this way, the coding efficiency and coding effectiveness can be improved.

In some embodiments, the at least two coding units are collected from at least one adjacent position, at least one non-adjacent position, or a history coding unit table, or parameter table.

In some embodiments, the at least two coding units are inter coded.

In some embodiments, the at least two coding units are coded with an affine mode, or wherein a partial of the at least two coding units is coded with an affine mode.

In some embodiments, none of the at least two coding units is coded with an affine mode.

In some embodiments, the at least two coding units share at least one of: a same prediction direction, a same reference list, a same reference index, or a same frame.

In some embodiments, the at least two coding units have at least one of: different prediction directions, different reference lists, different reference indexes, or different frames.

In some embodiments, a prediction direction comprises a bi-direction or a uni-direction.

In some embodiments, if the number of subblocks of the at least two coding units is larger than a threshold, the at least one regression affine candidate is determined.

In some embodiments, the at least one regression affine candidate is determined further based on motion fields of neighboring or non-adjacent positions.

In some embodiments, the motion fields of neighboring or non-adjacent positions comprises at least one of: a first number of rows of neighboring subblocks, a first number of columns of neighboring subblocks, a second number of rows of non-adjacent subblocks, or a second number of columns of non-adjacent subblocks.

In some embodiments, locations of the non-adjacent positions are based on a block dimension of the target video block.

In some embodiments, if the number of existing regression candidates of the target video block is less than a maximum allowed number, the at least one regression candidate is used for the target video block.

In some embodiments, the method 2800 further comprises: reordering the at least one regression candidate based on a metric.

In some embodiments, the metric comprises at least one of: an adaptive reorder of merge candidates (AMRC), or a template matching.

In some embodiments, the number of the at least one regression candidate is less than or equal to a value, wherein the values is a constant, or being adaptively determined.

According to further embodiments of the present disclosure, a non-transitory computer-readable recording medium is provided. The non-transitory computer-readable recording medium stores a bitstream of a video which is generated by a method performed by an apparatus for video processing. The method comprises: determining motion fields of at least two coding units coded before a target video block of the video; determining at least one regression affine candidate of the target video block based on the motion fields of the at least two coding units; and generating the bitstream based on the at least one regression affine candidate.

According to still further embodiments of the present disclosure, a method for storing bitstream of a video is provided. The method comprises: determining motion fields of at least two coding units coded before a target video block of the video; determining at least one regression affine candidate of the target video block based on the motion fields of the at least two coding units; generating the bitstream based on the at least one regression affine candidate; and storing the bitstream in a non-transitory computer-readable recording medium.

It is to be understood that the method 2600, the method 2700, and/or the method 2800 can be applied separately, or in any combination. With these methods, the coding efficiency and coding effectiveness can be improved.

Implementations of the present disclosure can be described in view of the following clauses, the features of which can be combined in any reasonable manner.
Clause 1. A method for video processing, comprising: determining, for a conversion between a target video block of a video and a bitstream of the video, a usage of an interweaved affine prediction based on at least one of a first coding tool, or coding information of the target video block; and performing the conversion based on the usage of the interweaved affine prediction.
Clause 2. The method of clause 1, wherein the first coding tool comprises a pixel based affine motion compensation.
Clause 3. The method of any of clauses 1-2, wherein the coding information of the target video block comprises dimension information of the target video block, and wherein determining the usage of the interweaved affine prediction comprises: determining whether the dimension information satisfies at least one condition, the at least one condition comprising at least one of: a first condition that at least one of a height or a width of the target video block is larger than or smaller than a dimension threshold, a second condition that a ratio of the height and the width of the target video block is larger than or smaller than a ratio threshold, or a third condition that a subblock size of the target video block is larger than or equal to a threshold size; and in accordance with a determination that the dimension information of the target video block satisfies the at least one condition, enabling the interweaved affine prediction.
Clause 4. The method of clause 3, wherein determining the usage of the interweaved affine prediction further comprises: in accordance with a determination that the dimension information of the target video block fails to satisfy the at least one condition, disabling the interweaved affine prediction.
Clause 5. The method of clause 3 or 4, further comprising: determining a usage of the first coding tool based on the dimension information.
Clause 6. The method of clause 5, wherein determining the usage of the first coding tool comprises: in accordance with a determination that the dimension information of the target video block fails to satisfy at least one condition, enabling the first coding tool.
Clause 7. The method of any of clauses 5-6, wherein the usage of at least one of the interweaved affine prediction or the first coding tool is determined further based on a flag of an overlapped block motion compensation (OBMC).
Clause 8. The method of clause 7, wherein if the flag of the OBMC indicates that the OBMC is enabled for the target video block and the dimension information satisfies the at least one condition, the first coding tool is enabled.
Clause 9. The method of clause 1 or 2, wherein the usage the interweaved affine prediction is based on information associated with the first coding tool.
Clause 10. The method of clause 9, wherein if the first coding tool is enabled for the target video block, the interweaved affine prediction is disabled.
Clause 11. The method of clause 1 or 2, wherein the interweaved affine prediction and the first coding tool are not simultaneously used for the target video block, or wherein the interweaved affine prediction and the first coding tool are simultaneously used for the target video block.
Clause 12. The method of any of clause 1 or 2, wherein partial pixels of the target video block are predicted by the interweaved affine prediction, and further pixels of the target video block are predicted by the first coding tool.
Clause 13. The method of clause 10 or 11, wherein a first prediction from the interweaved affine prediction and a second prediction from the first coding tool are blended to generate a third prediction.
Clause 14. The method of any of clauses 1-13, wherein if the interweaved affine prediction is enabled or the first coding tool is disabled, a size of a largest subblock of the target video block is a constant.
Clause 15. The method of any of clauses 1-14, wherein the interweaved affine prediction is enabled for the target video block, and the method further comprises performing a prediction refinement with optical flow (PROF) for the interweaved affine prediction.
Clause 16. The method of clause 15, wherein performing the PROF comprises: obtaining a first prediction and a second prediction of the target video block by applying the interweaved affine prediction, the first and second predictions corresponding to a first dividing pattern and a second dividing pattern; and obtaining a first refined prediction and a second refined prediction by performing the PROF on the first and second predictions.
Clause 17. The method of clause 16, wherein performing the PROF comprises: obtaining a first prediction and a second prediction of the target video block by applying the interweaved affine prediction, the first and second predictions corresponding to a first dividing pattern and a second dividing pattern; and obtaining a first refined prediction by performing the PROF on the first prediction, without refining the second prediction.
Clause 18. The method of clause 16 or 17, wherein for the first dividing pattern, partial prediction samples of the first prediction are refined by the PROF.
Clause 19. The method of clause 18, wherein if a width or a height of a subblock of the target video block is less than a threshold, the PROF is disabled for prediction samples of the subblock.
Clause 20. The method of any of clauses 1-14, wherein the interweaved affine prediction is enabled for the target video block, and a prediction refinement with optical flow (PROF) is disabled for the interweaved affine prediction.
Clause 21. The method of any of clauses 1-20, further comprising: determining whether to and/or how to apply at least one subblock-boundary based process to the target video block based on whether at least one of: an affine mode, a pixel-based affine, or an interweaved prediction is enabled.
Clause 22. The method of clause 21, wherein the at least one subblock-boundary based process comprises at least one of: a subblock-boundary deblocking process, a subblock-boundary based filtering process, a sample adaptive offset (SAO), an adaptive loop filter, or an overlapped block motion compensation (OBMC).
Clause 23. The method of clause 21 or 22, wherein if at least one of the affine mode, the pixel-based affine, or the interweaved prediction is enabled, at least partial of the at least one subblock-boundary based process is disabled.
Clause 24. The method of clause 21 or 22, wherein if at least one of the affine mode, the pixel-based affine, or the interweaved prediction is enabled, at least one of: a subblock-boundary based deblocking, or an overlapped block motion compensation (OBMC) is disabled.
Clause 25. A method for video processing, comprising: determining, for a conversion between a target video block of a video and a bitstream of the video, a usage of a coding unit (CU) level overlapped block motion compensation (OBMC) based on a coding mode of the target video block; and performing the conversion based on the usage of the CU-level OBMC.
Clause 26. The method of clause 25, wherein the usage of the CU-level OBMC comprises at least one of: whether to apply the CU-level OBMC, or how to apply the CU-level OBMC.
Clause 27. The method of clause 25 or 26, wherein if a subblock level inter coding mode is enabled for the target video block, each boundary subblock of the target video block conducts the CU level OBMC filtering independently.
Clause 28. The method of clause 27, wherein the subblock level inter coding mode comprises at least one of: an affine mode, a subblock-based temporal motion vector prediction (SbTMVP), or a multi-pass decoder side motion vector refinement (DMVR).
Clause 29. The method of clause 28, wherein applying the CU level OBMC filtering comprises: traversing a plurality of boundary subblocks of the target video block, wherein during the traversing for a first boundary subblock of the plurality of boundary subblocks of the target video block, in accordance with a determination that a motion of the first boundary subblock is different from a motion of a corresponding neighboring subblock for OBMC, applying the OBMC filtering to the first boundary subblock.
Clause 30. The method of clause 25 or 26, wherein if a non-subblock level inter coding mode is enabled for the target video block, a plurality of boundary subblocks of the target video block conducts the CU level OBMC filtering together.
Clause 31. The method of clause 30, wherein applying the CU level OBMC filtering comprises: traversing the plurality of boundary subblocks, wherein during the traversing of a first boundary subblock of the plurality of boundary subblocks, in accordance with a determination that a motion of the first boundary subblock is different from a set of motions of a set of neighboring subblocks, filtering a group of boundary subblocks of the plurality of subblocks together, wherein the set of motions is identical, the set of subblocks comprises a corresponding neighboring subblock of the first boundary subblock and a first number of successive subblocks of the neighbouring subblock, and the group of boundary subblocks comprising the first boundary subblock and the first number of successive boundary subblocks.
Clause 32. The method of clause 30, wherein if the motion of the first boundary subblock is same with the set of motions, the CU level OBMC filtering is skip for the first boundary subblock.
Clause 33. A method for video processing, comprising: determining, for a conversion between a target video block of a video and a bitstream of the video, motion fields of at least two coding units coded before the target video block; determining at least one regression affine candidate of the target video block based on the motion fields of the at least two coding units; and performing the conversion based on the at least one regression affine candidate.
Clause 34. The method of clause 33, wherein the at least two coding units are collected from at least one adjacent position, at least one non-adjacent position, or a history coding unit table, or parameter table.
Clause 35. The method of clause 33 or 34, wherein the at least two coding units are inter coded.
Clause 36. The method of any of clauses 33-35, wherein the at least two coding units are coded with an affine mode, or wherein a partial of the at least two coding units is coded with an affine mode.
Clause 37. The method of any of clauses 33-35, wherein none of the at least two coding units is coded with an affine mode.
Clause 38. The method of any of clauses 33-37, wherein the at least two coding units share at least one of: a same prediction direction, a same reference list, a same reference index, or a same frame.
Clause 39. The method of any of clauses 33-37, wherein the at least two coding units have at least one of: different prediction directions, different reference lists, different reference indexes, or different frames.
Clause 40. The method of clause 38 or 39, wherein a prediction direction comprises a bi-direction or a uni-direction.
Clause 41. The method of any of clauses 33-40, wherein if the number of subblocks of the at least two coding units is larger than a threshold, the at least one regression affine candidate is determined.
Clause 42. The method of any of clauses 33-41, wherein the at least one regression affine candidate is determined further based on motion fields of neighboring or non-adjacent positions.
Clause 43. The method of clause 42, wherein the motion fields of neighboring or non-adjacent positions comprises at least one of: a first number of rows of neighboring subblocks, a first number of columns of neighboring subblocks, a second number of rows of non-adjacent subblocks, or a second number of columns of non-adjacent subblocks.
Clause 44. The method of clause 42 or 43, wherein locations of the non-adjacent positions are based on a block dimension of the target video block.
Clause 45. The method of any of clauses 33-44, wherein if the number of existing regression candidates of the target video block is less than a maximum allowed number, the at least one regression candidate is used for the target video block.
Clause 46. The method of any of clauses 33-45, further comprising: reordering the at least one regression candidate based on a metric.
Clause 47. The method of clause 46, wherein the metric comprises at least one of: an adaptive reorder of merge candidates (AMRC), or a template matching.
Clause 48. The method of any of clauses 33-47, wherein the number of the at least one regression candidate is less than or equal to a value, wherein the values is a constant, or being adaptively determined.
Clause 49. The method of any of clauses 1-48, wherein the conversion includes encoding the target video block into the bitstream.
Clause 50. The method of any of clauses 1-48, wherein the conversion includes decoding the target video block from the bitstream.
Clause 51. An apparatus for video processing comprising a processor and a non-transitory memory with instructions thereon, wherein the instructions upon execution by the processor, cause the processor to perform a method in accordance with any of clauses 1-50.
Clause 52. A non-transitory computer-readable storage medium storing instructions that cause a processor to perform a method in accordance with any of clauses 1-50.
Clause 53. A non-transitory computer-readable recording medium storing a bitstream of a video which is generated by a method performed by an apparatus for video processing, wherein the method comprises: determining a usage of an interweaved affine prediction based on at least one of a first coding tool, or coding information of a target video block of the video; and generating the bitstream based on the usage of the interweaved affine prediction.
Clause 54. A method for storing a bitstream of a video, comprising: determining a usage of an interweaved affine prediction based on at least one of a first coding tool, or coding information of a target video block of the video; generating the bitstream based on the usage of the interweaved affine prediction; and storing the bitstream in a non-transitory computer-readable recording medium.
Clause 55. A non-transitory computer-readable recording medium storing a bitstream of a video which is generated by a method performed by an apparatus for video processing, wherein the method comprises: determining a usage of a coding unit (CU) level overlapped block motion compensation (OBMC) based on a coding mode of a target video block of the video; and generating the bitstream based on the usage of the CU-level OBMC.
Clause 56. A method for storing a bitstream of a video, comprising: determining a usage of a coding unit (CU) level overlapped block motion compensation (OBMC) based on a coding mode of a target video block of the video; generating the bitstream based on the usage of the CU-level OBMC; and storing the bitstream in a non-transitory computer-readable recording medium.
Clause 57. A non-transitory computer-readable recording medium storing a bitstream of a video which is generated by a method performed by an apparatus for video processing, wherein the method comprises: determining motion fields of at least two coding units coded before a target video block of the video; determining at least one regression affine candidate of the target video block based on the motion fields of the at least two coding units; and generating the bitstream based on the at least one regression affine candidate.
Clause 58. A method for storing a bitstream of a video, comprising: determining motion fields of at least two coding units coded before a target video block of the video; determining at least one regression affine candidate of the target video block based on the motion fields of the at least two coding units; generating the bitstream based on the at least one regression affine candidate; and storing the bitstream in a non-transitory computer-readable recording medium.

### Example Device

FIG. 29 illustrates a block diagram of a computing device 2900 in which various embodiments of the present disclosure can be implemented. The computing device 2900 may be implemented as or included in the source device 110 (or the video encoder 114 or 200) or the destination device 120 (or the video decoder 124 or 300).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement video encoding/decoding in embodiments of the present disclosure. The memory 2920 may include one or more video coding modules 2925 having one or more program instructions. These modules are accessible and executable by the processing unit 2910 to perform the functionalities of the various embodiments described herein.

In the example embodiments of performing video encoding, the input device 2950 may receive video data as an input 2970 to be encoded. The video data may be processed, for example, by the video coding module 2925, to generate an encoded bitstream. The encoded bitstream may be provided via the output device 2960 as an output 2980.

In the example embodiments of performing video decoding, the input device 2950 may receive an encoded bitstream as the input 2970. The encoded bitstream may be processed, for example, by the video coding module 2925, to generate decoded video data. The decoded video data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a target video block of a video and a bitstream of the video, a usage of an interweaved affine prediction based on at least one of a first coding tool, or coding information of the target video block; and
performing the conversion based on the usage of the interweaved affine prediction.

2. The method of claim 1, wherein the first coding tool comprises a pixel based affine motion compensation.

3. The method of claim 1, wherein the coding information of the target video block comprises dimension information of the target video block, and wherein determining the usage of the interweaved affine prediction comprises:
determining whether the dimension information satisfies at least one condition, the at least one condition comprising at least one of:
a first condition that at least one of a height or a width of the target video block is larger than or smaller than a dimension threshold,
a second condition that a ratio of the height and the width of the target video block is larger than or smaller than a ratio threshold, or
a third condition that a subblock size of the target video block is larger than or equal to a threshold size; and
in accordance with a determination that the dimension information of the target video block satisfies the at least one condition, enabling the interweaved affine prediction.

4. The method of claim 3, wherein determining the usage of the interweaved affine prediction further comprises:
in accordance with a determination that the dimension information of the target video block fails to satisfy the at least one condition, disabling the interweaved affine prediction.

5. The method of claim 3, further comprising:
determining a usage of the first coding tool based on the dimension information.

6. The method of claim 5, wherein determining the usage of the first coding tool comprises:
in accordance with a determination that the dimension information of the target video block fails to satisfy at least one condition, enabling the first coding tool.

7. The method of claim 6, wherein the usage of at least one of the interweaved affine prediction or the first coding tool is determined further based on a flag of an overlapped block motion compensation (OBMC),
wherein if the flag of the OBMC indicates that the OBMC is enabled for the target video block and the dimension information satisfies the at least one condition, the first coding tool is enabled.

8. The method of claim 1, wherein the usage the interweaved affine prediction is based on information associated with the first coding tool,
wherein if the first coding tool is enabled for the target video block, the interweaved affine prediction is disabled.

9. The method of claim 1, wherein the interweaved affine prediction and the first coding tool are not simultaneously used for the target video block, or
wherein the interweaved affine prediction and the first coding tool are simultaneously used for the target video block.

10. The method of any of claim 1, wherein partial pixels of the target video block are predicted by the interweaved affine prediction, and further pixels of the target video block are predicted by the first coding tool, wherein a first prediction from the interweaved affine prediction and a second prediction from the first coding tool are blended to generate a third prediction.

11. The method of claim 1, wherein if the interweaved affine prediction is enabled or the first coding tool is disabled, a size of a largest subblock of the target video block is a constant.

12. The method of claim 1, wherein the interweaved affine prediction is enabled for the target video block, and the method further comprises performing a prediction refinement with optical flow (PROF) for the interweaved affine prediction.

13. The method of claim 12, wherein performing the PROF comprises:
obtaining a first prediction and a second prediction of the target video block by applying the interweaved affine prediction, the first and second predictions corresponding to a first dividing pattern and a second dividing pattern; and
obtaining a first refined prediction and a second refined prediction by performing the PROF on the first and second predictions,
wherein performing the PROF comprises:
obtaining a first prediction and a second prediction of the target video block by applying the interweaved affine prediction, the first and second predictions corresponding to a first dividing pattern and a second dividing pattern; and
obtaining a first refined prediction by performing the PROF on the first prediction, without refining the second prediction,
wherein for the first dividing pattern, partial prediction samples of the first prediction are refined by the PROF, wherein if a width or a height of a subblock of the target video block is less than a threshold, the PROF is disabled for prediction samples of the subblock.

14. The method of claim 1, wherein the interweaved affine prediction is enabled for the target video block, and a prediction refinement with optical flow (PROF) is disabled for the interweaved affine prediction.

15. The method of claim 1, further comprising:
determining whether to and/or how to apply at least one subblock-boundary based process to the target video block based on whether at least one of: an affine mode, a pixel-based affine, or an interweaved prediction is enabled.

16. The method of claim 15, wherein the at least one subblock-boundary based process comprises at least one of: a subblock-boundary deblocking process, a subblock-boundary based filtering process, a sample adaptive offset (SAO), an adaptive loop filter, or an overlapped block motion compensation (OBMC),
wherein if at least one of the affine mode, the pixel-based affine, or the interweaved prediction is enabled, at least partial of the at least one subblock-boundary based process is disabled, or
wherein if at least one of the affine mode, the pixel-based affine, or the interweaved prediction is enabled, at least one of: a subblock-boundary based deblocking, or an overlapped block motion compensation (OBMC) is disabled.

17. The method of claim 1, wherein the conversion includes encoding the target video block into the bitstream, or
wherein the conversion includes decoding the target video block from the bitstream.

18. An apparatus for video processing comprising a processor and a non-transitory memory with instructions thereon, wherein the instructions upon execution by the processor, cause the processor to:
determine, for a conversion between a target video block of a video and a bitstream of the video, a usage of an interweaved affine prediction based on at least one of a first coding tool, or coding information of the target video block; and
perform the conversion based on the usage of the interweaved affine prediction.

19. A non-transitory computer-readable storage medium storing instructions that cause a processor to perform acts comprising:
determining, for a conversion between a target video block of a video and a bitstream of the video, a usage of an interweaved affine prediction based on at least one of a first coding tool, or coding information of the target video block; and
performing the conversion based on the usage of the interweaved affine prediction.

20. A non-transitory computer-readable recording medium storing a bitstream of a video which is generated by a method performed by an apparatus for video processing, wherein the method comprises:
determining a usage of an interweaved affine prediction based on at least one of a first coding tool, or coding information of a target video block of the video; and
generating the bitstream based on the usage of the interweaved affine prediction.
